(19) United States
(12) Patent Application Publication
(10) Pub. No.: US 2011/0003100 A1
(43) Pub. Date: Jan. 6, 2011

(54) POLYESTER COMPOSITION AND POLYESTER MOLDED ARTICLE COMPRISING THE SAME

(75) Inventors: Keiichiro Togawa, Ohtsu-shi (JP); Seiji Nakayama, Iwakuni-shi (JP); Gaku Maruyama, Tsuruga-shi (JP); Yoshiko Akitomo, Ohtsu-shi (JP); Yoshinao Matsui, Osaka-shi (JP); Yoshitaka Eto, Ohtsu-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TOYO BOSEKI KABUSHIKI KAISHA, Osaka-shi (JP)

(21) Appl. No.: 12/303,230

(22) PCT Filed: May 30, 2007
(86) PCT No.: PCT/JP2007/060973

§ 371 Date: May 14, 2009

(30) Foreign Application Priority Data
Jun. 2, 2006 (JP) 2006-154840
Jun. 2, 2006 (JP) 2006-154844

(51) Int. Cl. C08L 85/02; B32B 27/08

(52) U.S. Cl. 428/35.7; 525/389

(57) ABSTRACT

A polyester composition comprising 99.9 to 80 wt % of a thermoplastic polyester containing an antimony compound and 0.1 to 20 wt % of a partially aromatic polyamide, wherein a 4 mm-thick molded plate formed by molding the thermoplastic polyester at 290° C. has a haze value of 10% or lower, and wherein the phosphorus atom content in the partially aromatic polyamide (P1), the partially aromatic polyamide content in the polyester composition (A), and the antimony atom content in the thermoplastic polyester (S) satisfy a specific formula, wherein a 4 mm-thick molded plate produced by molding the polyester composition at 290° C. has a haze value of 20% or lower. The polyester composition can be molded into a hollow molded article (e.g., a bottle) at a high productivity rate, which is not deteriorated in transparency or color, and which is excellent in flavor-conserving property, thermal stability and gas-barrier property.

### TECHNICAL FIELD

The present invention relates to a polyester composition which can mold a hollow molded article such as a bottle and the like at high productivity, does not damage transparency or color tone, is excellent in flavor retainability and thermal stability, and is excellent in gas barrier property, and a polyester molded article obtained from the composition.

### BACKGROUND ART

Since a thermoplastic polyester such as polyethylene terephthalate (hereinafter, abbreviated as PET in some cases) is excellent in both of mechanical nature and chemical nature, it has high industrial value, and is widely used as fiber, film, sheet form product, or bottle. Further, since thermoplastic polyester is excellent in heat resistance, transparency and gas barrier property, it is optimal as a material for a molded article such as a container for filling drinks such as, particularly, juice, refreshing drinks, and carbonated drinks.

Such the thermoplastic polyester is produced into a bottle, for example, by supplying it to a molding machine such as an injection molding machine to form a preform for a hollow molded article, and inserting this preform into a mold having a predetermined shape, followed by stretch-blow molding. When used in utility of drinks requiring heat resistance, a plug of the bottle is heat-treated with an infrared heating apparatus or the like to crystallize the plug and, then, and a body of the bottle is heat-treated (heat-set).

However, in a bottle made of polyethylene terephthalate, there is a problem that at a crystallization treatment of a plug, time is needed and, at the same time, local difference in crystallization degree arises between inner side and outer side of the plug, thus, dimensional precision of the plug is not stabilized and, in heat treatment of the body, there is problem that transparency of body of the resulting bottle is reduced, or blowing mold set at high temperature is contaminated, and surface smoothness of the resulting bottle is damaged, resulting in a bottle with a body having deteriorated transparency.

On the other hand, in order to shorten the heat treatment time, and realize both of various physical properties such as heat resistance imparted by heat treatment, and transparency in a bottle made of polyethylene terephthalate, introduction of a copolymerization component into polyethylene terephthalate was studied and, for example, a copolymerized polyester resin using polyalkylene glycol such as polytetramethylene glycol and the like as a copolymerization diol component for a dicarboxylic acid component containing terephthalic acid as main component and a diol component containing ethylene glycol as main component, and a bottle comprising the same have been proposed (for example, see Patent Literatures 1, 2). However, bottles of copolymerized polyester resins described in these respective gazettes cannot be said to be sufficient in plug crystallization property and body thermal fixing property, and it was found out that there is problem in heat resistance, transparency, and flavor retainability.

In addition, as a method of improving productivity of heat treating step, a procedure of improving the infrared absorbing ability is disclosed. For example, method of adding carbon black (for example, see Patent Literature 3), a method of precipitating particle of antimony metal using mixed solution of an antimony compound and a trivalent phosphorus compound used as polycondensation catalyst (for example, see Patent Literatures 4, 5, 6), and method of adding compound having the infrared absorbing ability (for example, see Patent Literature 7) are disclosed. However, these techniques have problem of deteriorating transparency of a molded article, and problem of variation in the infrared absorbing ability between molded articles, and difficulty in uniform crystallization of problem, thus, improvement is desired.

### Patent Literature 1: Japanese Patent Application Laid-Open (JP-A) No. 9-227663

### Patent Literature 2: JP-A No. 9-277358

### Patent Literature 3: JP-A No. 58-157853

### Patent Literature 4: Japanese Patent Application Publication (JP-B) No. 49-20638

### Patent Literature 5: JP-A No. 11-222519

### Patent Literature 6: JP-A No. 2000-72864

### Patent Literature 7: Japanese Patent Application National Publication (Laid-Open) No. 2001-502254

### BRIEF DESCRIPTION OF THE DRAWINGS

FIG. 1 is plane view of molded plate with step used in Examples of the present invention (respective symbols are as follows; A: site A part of molded plate with step, B: site B part of molded plate with step, C: site C part of molded plate with step, D: site D part of molded plate with step, E: site E part of molded plate with step, F: site F part with molded plate with step, G: gate part of molded plate with step) FIG. 2 is side view of the molded plate with step of FIG. 1.

### DISCLOSURE OF THE INVENTION

### Problems to be Solved by the Invention

An object of the present invention is to solve the problems of the above-described background art, and provide a polyester composition containing a polyester and a partially aromatic polyamide using an antimony compound as catalyst, which can mold a hollow molded article such as a bottle and the like at high productivity, does not damage transparency and color tone, and is excellent in flavor retainability and heat stability, or flavor retainability, heat stability and gas barrier property, and a polyester molded article comprising the same.

### Means to Solve the Problems

The present inventors studied a polyester composition which can mold, at high productivity, a polyester molded article not damaging transparency and color tone, and excellent in flavor retainability and heat resistance, or flavor retainability and gas barrier property, using a polyester composition containing 99.9 to 80% by weight of a thermoplastic polyester and 0.1 to 20% by weight of a partially aromatic polyamide containing an antimony compound, resulting in completion of the present invention.

That is, the present invention is as follows:

[1] A polyester composition coprising 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, phosphorus atom content (P1) in the partially aromatic polyamide, the partial aromatic polyamide content (A) in the polyester composition, and antimony atom content (S) in the thermoplastic polyester satisfy the following equation (1), and haze of a molded plate of 4 mm thickness obtained by molding the polyester composition at 290° C. is 20% or less. (Provided that P1 is content of phosphorus'atom derived from a phosphorus compound detected in structure of the following structural formula (Formula 1), when the partially aromatic polyamide is dissolved in a solvent for ³¹P-NMR measurement solvent, trifluoroacetic acid is added, and the structure is analyzed.)

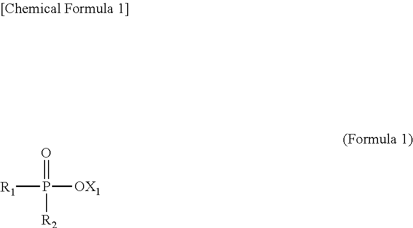

(In (Formula 1), R₁ and R₂ represent hydrogen, an alkyl group, an aryl group, a cycloalkyl group or an arylalkyl group, and X₁ represents hydrogen)

200≦(P1×A×S)/100≦2000 (1)

In the equation (1),

P1: content (ppm) of phosphorus atom derived from a phosphorus compound detected in the structural formula (Formula 1) of the partially aromatic aromatic amide

Content (% by weight) of a partially aromatic polyamide in polyester composition

S: antimony atom content (ppm) in thermoplastic polyester

[2] A polyester composition comprising 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, content (P1) of phosphorus atom in the partially aromatic polyamide, content (P2) of phosphorus atom in the partial aromatic polyamide, content (A) of the partially aromatic polyamide in the polyester composition and antimony atom content (S) in the thermoplastic polyester satisfy the following equation (2), and haze of a molded plate of 4 mm thickness obtained by molding the polyester composition at 290° C. is 20% or less.

(provided that P1 is content of phosphorus atom derived from a phosphorus compound detected in structure of the structural formula (Formula 1), and P2 is content of phosphorus atom derived from a phosphorus compound detected in structure of the structural formula (Formula 2), when the partially aromatic polyamide is dissolved in a solvent for ³¹P-NMR measurement, trifluoroacetic acid is added, and structure is analyzed)

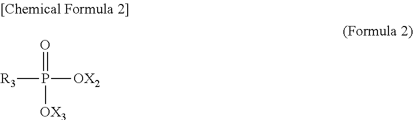

(In (Formula 2), R₃ represents hydrogen, an alkyl group, an aryl group, a cycloalkyl group or an arylalkyl group, and X₂ and X₃ represent hydrogen)

300≦{(P1+P2)×A×S}/100≦3000 (2)

In the equation (2),

P1: content (ppm) of phosphorus atom derived from a phosphorus compound detected in the structural formula (Formula 1) in the partially aromatic aromatic polyamide

P2: content (ppm) of phosphorus atom derived from a phosphorus compound detected in the structural formula (Formula 2) in the partially aromatic aromatic polyamide

Content (% by weight) of partially aromatic polyamide in polyester composition

S: antimony atom content (ppm) in thermoplastic polyester

[3] The polyester composition according to [1] or [2], wherein antimony atom content remaining in thermoplastic polyester is 100 to 400 ppm.

[4] The polyester composition according to any one of [1] to [3], wherein acetaldehyde content of a molded article obtained by injection-molding a polyester composition is 15 ppm or less.

[5] The polyester composition according to any one of [1] to [4], wherein antimony atom concentration dissolved in water is 1.0 ppb or less when a molded article obtained from the polyester composition is extracted with hot water.

[6] A polyester molded article obtained by molding the polyester composition as defined in any one of [1] to [5].

[7] The polyester molded article according to [6], wherein the polyester molded article is any one of a hollow molded article, a sheet form article, and a stretched film obtained by stretching this sheet form article at least in one direction.

In addition, the present invention completed by studying a polyester composition which can be molded at higher productivity is as follows:

[8] A polyester composition comprising 99.9 to 80% by weight of a thermoplastic polyester containing an antimony compound and 0.1 to 20% by weight of a partially aromatic polyamide, wherein a time (T1) for heating a pre-molded article containing the polyester composition when the pre-molded article is heated to 180° C., and time (T2) for heating the pre-molded article consisting only of the thermoplastic polyester similarly satisfy the following equation (3).

(T2−T1)/T2≧0.03 (3)

[9] The polyester composition according to [8], containing 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, content (P1) of phosphorus atom in the partially aromatic polyamide, content (A) of the partially aromatic polyamide in the polyester composition, and antimony atom content (S) in the thermoplastic polyester satisfy the following equation (4), and haze of a molded plate of 4 mm thickness obtained by molding the polyester compound at 290° C. is 20% or less.

(provided that, P1 is content of phosphorus atom derived from a phosphorus compound detected in a structure of the structural formula (Formula 1))

300≦(P1×A×S)/100≦2000 (4)

In the equation (4),

P1: content (ppm) of phosphorus atom derived from a phosphorus compound detected in the structural formula (Formula 1) in the partially aromatic aromatic polyamide

A: content (% by weight) of the partially aromatic aromatic polyamide in the polyester composition

S: antimony atom content (ppm) in a thermoplastic polyester

[10] The polyester composition according to [8], comprising 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, content (P1) of phosphorus atom in the partially aromatic polyamide, content (P2) of phosphorus atom in the partially aromatic polyamide, content (A) of the partially aromatic polyamide in the polyester composition and antimony atom content (S) in the thermoplastic polyester satisfy the following equation (5), and haze of a molding plate of 4 mm thickness obtained by molding the polyester composition at 290° C. is 20% or less. (provided that, P1 is content of phosphorus atom derived from a phosphorus compound detected in a structure of the structural formula (Formula 1), and P2 is content of phosphorus atom derived from a phosphorus compound detected in a structure of the structural formula (Formula 2))

400≦{(P1+P2)×A×S}/100≦3000 (5)

In the equation (5),

P1: content (ppm) of phosphorus atom derived from a phosphorus compound detected in the structural formula (Formula 1) in the partially aromatic aromatic polyamide

P2: content (ppm) of phosphorus atom derived from a phosphorus compound detected in the structural formula (Formula 2) in the partially aromatic aromatic polyamide

A: content (% by weight) of the partially aromatic aromatic polyamide in the polyester composition

S: antimony atom content (ppm) in the thermoplastic polyester

[11] The polyester composition according to any one of [8] to [10], wherein antimony atom content remaining in the thermoplastic polyester is 100 to 400 ppm.

[12] The polyester composition according to any one of [8] to [11], wherein acetaldehyde content of a molded article obtained by injection-molding the polyester composition is 15 ppm or less.

[13] The polyester composition according to any one of [8] to [12], wherein when a molded article obtained from the polyester composition is extracted with hot water, antimony atom concentration dissolved in the water is 1.0 ppb or less.

[14] A polyester molded article obtained by molding the polyester composition as defined in any one of [8] to [13].

[15] The polyester molded article according to [14], wherein the polyester molded article is any one of a hollow molded article, a sheet form article, and a stretched film obtained by stretching this sheet form article at least in one direction.

### EFFECT OF THE INVENTION

According to the polyester composition of the present invention, a polyester molded article which does not damage transparency and color tone, and is excellent in flavor retainability and thermal stability, or flavor retainability, heat stability and gas barrier property is obtained, its productivity is high, and the polyester molded article of the present invention is very suitable as a molded article for drinks such as refreshing drinks as described above.

### BEST MODE FOR CARRYING OUT THE INVENTION

Embodiments of the polyester composition of the present invention and a polyester molded article comprising the same will be specifically explained below.

### (Thermoplastic Polyester)

The thermoplastic polyester used in the present invention is a crystalline thermoplastic polyester obtained from mainly an aromatic dicarboxylic acid component and a glycol component, further preferably a thermoplastic polyester in which an aromatic dicarboxylic acid unit is contained at 85% by mol or more of an acid component, particularly preferably a thermoplastic polyester in which an aromatic dicarboxylic acid unit is contained at particularly preferably 90% by mol or more, most preferably 95% by mol or more of an acid component.

Examples of the aromatic dicarboxylic acid component constituting the thermoplastic polyester used in the present invention include aromatic dicarboxylic acids such as terephthalic acid, 2,6-naphthalenedicarboxylic acid, diphenyl-4,4′-dicarboxylic acid, diphenoxyethanedicarboxylic acid and the like, and a functional derivative thereof.

In addition, examples of a glycol component constituting the thermoplastic polyester used in the present invention include aliphatic glycols such as ethylene glycol, 1,3-trimethylene glycol, and tetramethylene glycol, alicyclic glycols such as cyclohexanedimethanol, and the like.

Examples of the acid component used as a copolymerization component in the thermoplastic polyester include aromatic dicarboxylic acids such as terephthalic acid, 2,6-naphthalenedicarboxylic acid, isophthalic acid, diphenyl-4-4′-dicarboxylic acid, diphenoxyethanedicarboxylic acid and the like, oxyacids such as p-oxybenzoic acid, oxycaproic acid, and the like, and a functional derivative thereof, aliphatic dicarboxylic acids such as adipic acid, sebacic acid, succinic acid, glutaric acid, dimer acid, and the like, and a functional derivative thereof, and alicyclic dicarboxylic acids such as hexahydroterephthalic acid, hexahydroisophthalic acid, cyclohexanedicarboxylic acid and the like, and a functional derivative thereof.

Examples of the glycol component used as a copolymerization component in the thermoplastic polyester include aliphatic glycols such as ethylene glycol, 1,3-trimethylene glycol, tetramethylene glycol, diethylene glycol, neopentyl glycol, and the like, alicyclic glycols such as cyclohexanedimethanol, and the like, aromatic glycols such as 1,3-bis(2-hydroxyethoxy)benzene, bisphenol A, alkylene oxide adduct of bisphenol A and the like, and polyalkylene glycols such as polyethylene glycol, polybutylene glycol, and the like.

Further, a polyfunctional compound, for example, trimellitic acid, trimesic acid, pyromellitic acid, tricarballylic acid, glycerin, pentaerythritol, trimethylolpropane, and the like may be copolymerized in such range that the thermoplastic polyester is substantially linear. Alternatively, a monofunctional compound, for example, benzoic acid, naphthoic acid and the like may be copolymerized.

As the thermoplastic polyester related to the present invention, a polyester containing 70% by mol or more of a constituent unit derived from aromatic dicarboxylic acid, and at least one kind glycol selected from aliphatic glycols having 2 to 4 carbon atoms is preferable.

A preferable one example of the thermoplastic polyester used in the present invention is a thermoplastic polyester composed of ethylene terephthalate as main repeating unit, further preferably a linear copolymerized thermoplastic polyester containing isophthalic acid, 2,6-naphthalenedicarboxylic acid, and 1,4-cyclohexanedimethanol as a copolymerization component, particularly preferably a linear thermoplastic polyester containing 85% by mol or more of an ethylene terephthalate unit.

Examples of the linear thermoplastic polyester include polyethylene terephthalate (hereinafter, abbreviated as PET), poly(ethylene terephthalate-ethylene isophthalate) copolymer, poly(ethylene terephthalate-ethylene isophthalate-ethylene-2,6-naphthalate) copolymer, poly(ethylene terephthalate-1,4-cyclohexanedimethylene terephthalate) copolymer, poly(ethylene terephthalate-ethylene-2,6-naphthalate) copolymer, poly(ethylene terephthalate-dioxyethylene terephthalate) copolymer, poly(ethylene terephthalate-1,3-propylene terephthalate) copolymer, and poly(ethylene terephthalate-ethylene cyclohexylene dicarboxylate) copolymer.

In addition, a preferable other one example of the thermoplastic polyester used in the present invention is a thermoplastic polyester in which main repeating unit is composed of ethylene-2,6-naphthalate, further preferably a linear thermoplastic polyester in which 85% by mol or more of ethylene-2,6-naphthalate unit is contained, particularly preferably a linear thermoplastic polyester containing 95% by mol or more of ethylene-2,6-naphthalate unit.

Examples of the linear thermoplastic polyester include polyethylene-2,6-naphthalate (PEN), poly(ethylene-2,6-naphthalate-ethylene terephathalate) copolymer, poly(ethylene-2,6-naphthalate-ethylene isophthalate) copolymer, and poly(ethylene-2,6-naphathalate-dioxyetheylene-2,6-naphthalate) copolymer.

Furthermore, a preferable other example of the thermoplastic polyester related to the present invention is a thermoplastic polyester in which main constituent unit is composed of 1,3-propylene terephthalate, further preferable is a linear thermoplastic polyester containing 70% by mol or more of 1,3-propylene terephthalate unit, and particularly preferable is a linear thermoplastic polyester containing 90% by mol or more of 1,3-propylene terephthalate unit.

Examples of these linear thermoplastic polyesters include polypropylene terephthalate (PTT), poly(1,3-propylene terephthalate-1,3-propylene isophthalate) copolymer, poly(1,3-propylene terephthalate-1,4-cyclohexanedimethylene terephthalate) copolymer, and poly(1,3-propylene terephthalate-1,3-propylene-2,6-naphthalate) copolymer.

Preferable other examples of the thermoplastic polyester related to the present invention other than the foregoing include a thermoplastic polyester in which a main constituent unit is composed of 1,3-propylene-2,6-naphthalate, and a thermoplastic polyester in which main constituent unit is composed of butylene-2,6-naphthalate.

The thermoplastic polyester related to the present invention can be fundamentally produced by the previously known melt polycondensation method or melt polycondensation method-solid phase polymerization method. The melt polycondensation reaction may be performed at single stage, or may be performed by dividing into multiple stages. These may be constructed of a batch-type reaction apparatus, or may be constructed of a continuous reaction apparatus. Alternatively, melt-polycondensation step and solid phase polycondensation step may be operated continuously, or may be operated by division. Using an example of polyethylene terephthalate (PET), preferable one example of a process for continuously producing the polyester composition of the present invention will be explained below, but is not limited thereto. That is, in the case of PET, it is produced by direct esterification method of directly reacting terephthalic acid and ethylene glycol and, if necessary, the copolymerization component, distilling water off to esterify this and, thereafter, performing polycondensation under reduced pressure using an antimony compound as polycondensation catalyst, or transesterification method of reacting dimethyl terephthalate and ethylene glycol and, if necessary, the copolymerization component in the presence of transesterification catalyst, distilling methyl alcohol off to transesterify this and, thereafter, performing polycondensation mainly under reduced pressure using an antimony compound as polycondensation catalyst. And, as the polycondensation catalyst, in addition to the antimony compound, one or more kinds of compounds selected from a germanium compound, a titanium compound and an aluminum compound can be used supplementally.

Further, in order to increase intrinsic viscosity of the thermoplastic polyester, and reduce content of aldehydes such as acetaldehyde and content of a cyclic ester trimer, solid phase polymerization may be performed.

When low-molecular polymer is produced first by esterification reaction, slurry containing ethylene glycol at 1.02 to 2.0 mol, preferably 1.03 to 1.6 mol based on 1 mol of terephthalic acid or an ester derivative thereof is prepared, and this is continuously supplied to esterification reaction step.

The esterification reaction is performed under the condition of refluxing ethylene glycol using multi-stage apparatus in which at least two esterification reactors are connected in series, while water or alcohol generated by the reaction is removed in rectification tower to the outside of the system. Temperature of the esterification reaction at first stage is 240 to 270° C., preferably 245 to 265° C., and pressure is 0.2 to 3 kg/cm²G, preferably 0.5 to 2 kg/cm²G. Temperature of the esterification reaction at final stage is usually 250 to 280° C., preferably 255 to 275° C., and pressure is usually 0 to 1.5 kg/cm²G, preferably 0 to 1.3 kg/cm²G. When the esterification reaction is performed at 3 or more stages, the reaction condition of the esterification reaction at intermediate stage is the condition between the reaction condition at the first stage and the reaction condition at final stage. It is preferable that increase in reaction rate of these esterification reactions is smoothly distributed at each stage. Finally, it is desirable that esterification reaction rate reaches 90% or more, preferably 93% or more. By these esterification reactions, low-order polycondensate of molecular weight of around 500 to 5000 is obtained.

Although, the esterification reaction, when terephthalic acid is used as raw material, may be performed without a catalyst because of the catalyzing activity of terephthalic acid as an acid, it may be performed in the presence of a polycondensation catalyst.

In addition, when the esterification reaction is performed by adding small amount of tertiary amine such as triethylamine, poly-n-butylamine and benzyldimethylamine, quaternary ammonium hydroxide such as tetraethylammonium hydroxide, tetra-n-butyl ammonium hydroxide, and trimethylbenzyl ammonium hydroxide, and a basic compound such as lithium carbonate, sodium carbonate, potassium carbonate, and sodium acetate, ratio of a dioxyethylene terephthalate component unit in main chain of polyethylene terephthalate can be retained at relatively low level (5% by mol or less based on total diol component), being preferable.

Then, when a low-molecular polymer is produced by the transesterification reaction, solution containing ethylene glycol at 1.1 to 2.0 mol, preferably 1.2 to 1.5 mol based on 1 mol of dimethyl terephthalate is prepared, and this is continuously supplied to transesterification reaction step.

The transesterification reaction is performed under the condition of refluxing ethylene glycol using an apparatus in which one to two transesterification reaction reactors are connected in series, while methanol generated by the reaction is removed in rectification tower to the outside of the system. Temperature of the transesterification reaction at first stage is 180 to 250° C., preferably 200 to 240° C. Temperature of the transesterification reaction at last stage is usually 230 to 270° C., preferably 240 to 265° C. and, as transesterification catalyst, a fatty acid salt or a carbonate salt of zinc, magnesium, manganese, potassium or barium, or an oxide of antimony or germanium is used. By these transesterification reactions, a low-order polycondensate having a molecular weight of about 200 to 500 is obtained.

As dimethyl aromatic dicarboxylate ester, aromatic dicarboxylic acid or glycols such as ethylene glycol which is the starting raw material, not only virgin dimethyl terephthalate derived from paraxylene, terephthalic acid, or ethylene glycol derived from ethylene, but also recovery raw material such as dimethyl terephthalate, terephthalic acid, bishydroxyethyl terephthalate or ethylene glycol recovered by a chemical recycle method such as methanol degradation and ethylene glycol degradation from used PET bottle can be utilized as at least a part of starting raw material. It goes without saying that the recovered raw material must be purified to purity and quality depending on the application purpose.

Then, the resulting low-order condensate is supplied to multi-stage liquid phase polycondensation step. The polycondensation reaction condition is such that reaction temperature of polycondensation reaction at first stage is 250 to 290° C., preferably 260 to 280° C., a pressure is 500 to 20 Torr, preferably 200 to 30 Torr, temperature of the polycondensation reaction at final stage is 265 to 300° C., preferably 275 to 295° C., and pressure is 10 to 0.1 Torr, preferably 5 to 0.5 Torr. When the polycondensation reaction is performed at 3 or more stages, the reaction condition of the polycondensation reaction at intermediate stage is the condition between the reaction condition at the first stage and the reaction condition at the last stage. Degree of increase in intrinsic viscosity attained at each of these polycondensation reaction steps is preferably distributed smoothly. In addition, a one-stage polycondensation apparatus may be used in the polycondensation reaction.

Examples of the antimony compound used in producing the thermoplastic polyester used in the present invention include antimony polyoxide, antimony acetate, antimony tartarate, antimony potassium tartarate, antimony oxychloride, antimony glycolate, antimony pentaoxide, triphenylantimony and the like. It is desirable that the antimony compound is added at an amount in terms of content of antimony (hereinafter, abbreviated as S in some cases) in the produced polymer, in the range of 100 to 400 ppm, preferably 130 to 350 ppm, further preferably 150 to 300 ppm, most preferably 170 to 250 ppm. When the amount is less than 100 ppm (0.82 mol per 1 ton of polymer), polycondensation rate is slowed, which causes problem for economical efficiency, and when the amount exceeds 400 ppm (3.28 mol per 1 ton of polymer), crystallization proceeds too much upon heating of a polyester pre-molded article with an infrared heating apparatus, normal stretching becomes difficult, and transparency and color tone deteriorate, thus being not preferable. These antimony compounds are used as solution in ethylene glycol.

In addition, it is preferable that a compound containing at least one kind metal atom selected from the group containing magnesium, calcium, cobalt, manganese and zinc is used together as a second metal compound. Use amount thereof is in the range of 0.1 to 3.0 mol, preferably 0.15 to 2.5 mol, further preferably 0.2 to 2.0 mol in 1 ton of a polymer, in terms of content of these metals (hereinafter, abbreviated as Me in some cases) in the thermoplastic polyester. When the amount is less than 0.1 mol per 1 ton of a polymer, transparency of a polyester molded article, particularly, polyester molded thick-wall article from the thermoplastic polyester is considerably deteriorated, being problematic. On the other hand, when the amount exceeds 3.0 mol, thermal stability of the thermoplastic polyester deteriorates, and content of aldehydes such as acetaldehyde becomes too great, which causes problem of flavor property in some cases.

As the magnesium compound, the calcium compound, the cobalt compound, the manganese compound, and the zinc compound used in producing the thermoplastic polyester used in the present invention, all compounds can be used as far as they are compounds soluble in a reaction system.

Examples of the magnesium compound include magnesium hydride, magnesium oxide, lower fatty acid salt such as magnesium acetate, alkoxide such as magnesium methoxide, and the like.

Examples of the calcium compound include calcium hydride, calcium hydroxide, lower fatty acid salt such as calcium acetate, alkoxide such as calcium methoxide, and the like.

Examples of the cobalt compound include lower fatty acid salt such as cobalt acetate, organic acid salt such as cobalt naphthenate, cobalt benzoate and the like, chloride such as cobalt chloride and the like, cobalt acetylacetonate, and the like.

Examples of the manganese compound include organic acid salt such as manganese acetate, manganese benzoate and the like, chloride such as manganese chloride and the like, alkoxide such as manganese methoxide and the like, manganese acetylacetonate, and the like.

Examples of the zinc compound include organic acid salt such as zinc acetate, zinc benzoate and the like, chloride such as zinc chloride and the like, alkoxide such as zinc methoxide and the like, zinc acetylacetonate, and the like.

It is preferable that the magnesium compound, the calcium compound, the cobalt compound, the manganese compound and the zinc compound are added before the transesterification reaction in the case of the transesterification reaction. These compounds are used as an ethylene glycol solution.

In addition, examples of the germanium compound which is used as the catalyst supplementally include formless germanium dioxide, crystalline germanium dioxide, germanium chloride, germanium tetraethoxide, germanium tetra-n-butoxide, germanium phosphite and the like. Use amount thereof is around 3 to 20 ppm in terms of content of germanium in the thermoplastic polyester.

In addition, examples of the titanium compound which is used as the catalyst supplementally include tetraalkyl titanate such as tetraethyl titanate, tetraisopropyl titanate, tetra-n-propyl titanate, tetra-n-butyl titanate and the like, and a partial hydrolysate thereof, titanyl oxalate compound such as titanyl oxalate, ammonium titanyl oxalate, sodium titanyl oxalate, potassium titanyl oxalate, calcium titanyl oxalate, strontium titanyl oxalate and the like, titanium trimellitate, titanium sulfate, titanium chloride, hydrolysate of titanium halide, titanium bromide, titanium fluoride, potassium titanate hexafluoride, ammonium titanate hexafluoride, cobalt titanate hexafluoride, manganese titanate hexafluoride, titanium acetylacetonate and the like. Use amount thereof is around 0.1 to 3 ppm in terms of content of titanium in the thermoplastic polyester.

In addition, examples of the aluminum compound which is used as the catalyst supplementally include specifically carboxylic acid salts such as aluminum formate, aluminum acetate, basic aluminum acetate, aluminum propionate, aluminum oxalate, aluminum acrylate, aluminum laurate, aluminum stearate, aluminum benzoate, aluminum trichloroacetate, aluminum lactate, aluminum citrate, and aluminum salicylate, inorganic acid salts such as aluminum chloride, aluminum hydroxide, aluminum chloride hydroxide, polyaluminum chloride, aluminum nitrate, aluminum sulfate, aluminum carbonate, aluminum phosphate, and aluminum phosphonate, aluminum alkoxides such as aluminum methoxide, aluminum ethoxide, aluminum n-butoxide, aluminum iso-propoxide, aluminum-n-butoxide, and aluminum-t-butoxide, aluminum chelate compounds such as aluminum acetylacetonate, aluminum acetylacetate, aluminum ethylacetoacetate, and aluminum ethylacetoacetate di-iso-propoxide, organic aluminum compounds such as trimethylaluminum, and triethylaluminum, partial hydrolysates thereof, and aluminum oxide. Among them, carboxylic acid salts, inorganic acid salts and chelate compounds are preferable and, among them, basic aluminum acetate, aluminum chloride, aluminum hydroxide, aluminum chloride hydroxide, polyaluminum chloride and aluminum acetylacetonate are particularly preferable. Use amount thereof is around 2 to 30 ppm in terms of content of aluminum in the thermoplastic polyester.

In addition, various phosphorus compounds can be used as the stabilizer, and a pentavalent phosphorus compound is particularly optimal. Examples include phosphoric acid, trimethyl phosphate ester, trimethyl phosphate ester, tributyl phosphate ester, triphenyl phosphate ester, monomethyl phosphate ester, dimethyl phosphate ester, monobutyl phosphate ester, dibutyl phosphate ester and the like, and these may be used alone, or two or more kinds may be used together. A use amount thereof is 1 to 100 ppm, preferably 3 to 50 ppm, further preferably 3 to 30 ppm in terms of content of phosphorus in the thermoplastic polyester. These phosphorus compounds are used as ethylene glycol solution.

In addition, ratio of Me relative to phosphorus content (hereinafter, abbreviated as P in some cases) (Me/P) is in the range of 0.1 to 2.0, preferably 0.2 to 1.9, further preferably 0.3 to 1.8. When Me/P is less than 0.1, transparency of a polyester molded article, particularly thick-wall molded article from the resulting thermoplastic polyester becomes considerably deteriorated. On the other hand, when Me/P exceeds 2, thermal stability of the thermoplastic polyester deteriorates, content of aldehydes such as acetaldehyde becomes too great, being problematic in flavor property in some cases.

It is preferable that the antimony compound is added from initial stage of esterification to intermediate stage of esterification. In addition, it is preferable that the second metal compound and the phosphorus compound are added at later stage of esterification.

In addition, in order to suppress reduction in a viscosity of the polyester composition of the present invention at melting, and suppress generation of low-molecular byproduct produced by thermal degradation of acetaldehyde and allylaldehyde having strong stimulating odor at drying before molding or heat treatment, it is preferable to add a hindered phenol-based antioxidant. As such the hindered phenol-based antioxidant, the known one may be used, and examples include pentaerythritol-tetrakis[3-(3,5-di-tert-butyl-4-hydroxyphenyl) propionate], 1,1,3-tris(2-methyl-4-hydroxy-5-tert-butylphenyl) butane, 1,3,5-trimethyl-2,4,6-tris(3,5-di-tert-butyl-4-hydroxybenzyl) benzene, 3,9-bis{2-[3-(3-tert-butyl-4-hydroxy-5-methylphenyl)propionyloxy]-1,1-dimethylethyl}-2,4,8,10-tetraoxaspiro[5,5]undecane, 1,3,5-tris(4-tert-butyl-3-hydroxy-2,6-dimethylbenzene)isophthalic acid, triethyl glycol-bis[3-(3-tert-butyl-5-methyl-4-hydroxyphenyl) propionate], 1,6-hexanediol-bis[3-(3,3-(3,5-di-tert-butyl-4-hydroxyphenyl) propionate], 2,2-thio-diethylene-bis[3-(3,5-di-tert-butyl-4-hydroxyphenyl) propionate], octadecyl-3-(3,5-di-tert-butyl-4-hydroxyphenyl)propionate), lithium[ethyl 3,5-di-tert-butyl-4-hydroxybenzylphosphonate], potassium [ethyl 3,5-di-tert-butyl-4-hydroxybenzylphosphonate], magnesium bis[ethyl 3,5-di-tert-butyl-4-hydroxybenzylphosphonate], magnesium bis[3,5-di-tert-butyl-4-hydroxybenzylsulfonic acid], calcium bis[ethyl 3,5-di-tert-butyl-4-hydroxybenzylphosphonate], calcium bis[3,5-di-tert-butyl-4-hydroxybenzylphosphonic acid], beryllium bis[methyl 3,5-di-tert-butyl-4-hydroxybenzylphosphonate], strontium bis[ethyl 3,5-di-tert-butyl-4-hydroxybenzylphosphonate], ethyl 3,5-di-tert-butyl-4-hydroxybenzylphosphonate, diethyl 3,5-di-tert-butyl-4-hydroxybenzylphosphonate, methyl 3,5-di-tert-butyl-4-hydroxybenzylphosphonate, dimethyl 3,5-di-tert-butyl-4-hydroxybenzylphosphonate, isopropyl 3,5-di-tert-butyl-4-hydroxybenzylphosphonate, diisopropyl 3,5-di-tert-butyl-4-hydroxybenzylphosphonate, phenyl 3,5-di-tert-butyl-4-hydroxybenzylphosphonate, and diphenyl 3,5-di-tert-butyl-4-hydroxybenzylphosphonate. In this case, the hindered phenol-based antioxidant may be bound to the thermoplastic polyester, and amount of the hindered phenol-based antioxidant in the polyester composition is preferably 1% by weight or less based on weight of the polyester, since when the amount exceeds 1% by weight, a product is colored in some cases and, even when added at 1% by weight or more, the ability to improve melt stability is saturated. The amount is preferably 0.02 to 0.5% by weight.

It is preferable that the above-obtained melt polycondensed polyester is formulated into chip in form of a post, a sphere, a square or a plate by format of extruding in cooling water in which content (Na) of sodium, content (Mg) of magnesium, content (Si) of silicon and content (Ca) of calcium satisfy at least one of the following (6) to (9), from a pore after completion of melt polycondensation, and cutting the polyester in water, or format of extruding the polyester in the air and, thereafter, immediately cutting it while cooled with cooling water having the same water quality as that described above.

Na≦1.0 (ppm) (6)

Mg≦1.0 (ppm) (7)

Si≦2.0 (ppm) (8)

Ca≦1.0 (ppm) (9)

It is preferable to use water satisfying all of (6) to (9).

The content (Na) of sodium in cooling water is preferably Na≦0.5 ppm, further preferably Na≦0.1 ppm. The content (Mg) of magnesium in cooling water is preferably Mg≦0.5 ppm, further preferably Mg≦0.1 ppm. In addition, the content (Si) of silicon in cooling water is preferably Si≦1.0 ppm, further preferably Si≦0.3 ppm. Further, the content (Ca) of calcium in cooling water is preferably Ca≦0.5 ppm, further preferably Ca≦0.1 ppm.

Lower limits of the content (Na) of sodium, the content (Mg) of magnesium, the content (Si) of silicon and the content (Ca) of calcium in cooling water are Na≧0.001 ppm, Mg≧0.001 ppm, Si≧0.02 ppm and Ca≧0.001 ppm. In order that the content is such the lower limit or less, the immense facility investment is necessary, and the operation expense becomes very high, thus, economic production is difficult.

When the polyester obtained by chipping while cooling using cooling water outside the above-described condition is solid phase-polymerized, a problem arises that, due to impurities in the cooling water, insoluble particle in the polyester molded article obtained under such the condition is increased, and the flavor property deteriorates, reducing the merchandise value.

In order to reduce sodium, magnesium, calcium or silicon in the cooling water, an apparatus of removing sodium, magnesium, calcium or silicon by step of feeding industrial water to chip cooling step is disposed on at least one place. In addition, in order to remove clay mineral such as particulated silicon dioxide and aluminosilicate salt, a filter is disposed. Examples of the apparatus for removing sodium, magnesium, calcium or silicon include an ion exchange apparatus, an ultrafiltration apparatus and a reverse osmotic membrane apparatus.

Then, it is preferable that the melt polycondensed polyester chip is pre-crystallized with a 2 or more stage continuous crystallizing apparatus under the inert gas atmosphere. For example, in the case of PET, it is preferable that PET is sequentially crystallized step-wisely under the condition of temperature of 100 to 180° C. for 1 minute to 5 hours at first stage pre-crystallization, then, under the condition of temperature of 160 to 210° C. for 1 minute to 3 hours at second stage pre-crystallization and, further, under the condition of temperature of 180 to 210° C. for 1 minute to 3 hours at second or more stage pre-crystallization. It is preferable that a crystallization degree of the chip after crystallization is in the range of 30 to 65%, preferably 35 to 63%, further preferably 40 to 60%. In addition, crystallization degree can be obtained from density of the chip.

Then, solid polymerization is performed under the inert gas atmosphere or under reduced pressure at temperature optimal to the prepolymer so that increase in an intrinsic viscosity by solid polymerization becomes 0.10 dl/g or more. For example, in the case of PET, temperature of solid phase polymerization is such that an upper limit is preferably 215° C. or less, further preferably 210° C. or less, particularly preferably 208° C. or less, and lower limit is 190° C. or more, preferably 195° C. or more.

It is preferable that, after completion of solid phase polymerization, chip temperature is rendered about 70° C. or less, preferably 60° C. or less, further preferably 50° C. or less within about 30 minutes, preferably in 20 minutes, further preferably in 10 minutes.

Alternatively, the above-obtained thermoplastic polyester may be treated by contacting with water, water steam or a water steam-containing gas.

Examples of the hot water treating method include a method of immersing the thermoplastic polyester in water, and a method of spraying water on the chip with a shower. Treating time is minutes to 2 days, preferably 10 minutes to 1 day, further preferably 30 minutes to 10 hours, and temperature of water is 20 to 180° C., preferably 40 to 150° C., further preferably 50 to 120° C. As water to be used, water satisfying at least one of the above described (6) to (9) is preferable, and water satisfying all of the (6) to (9) is most preferable.

In addition, when the chip of the thermoplastic polyester is treated by contacting with water steam or a water steam-containing gas, water steam or a water steam-containing gas or the water steam-containing air at a temperature of 50 to 150° C., preferably 50 to 110° C. is supplied or present at amount of preferably 0.5 g or more in terms of a water steam per 1 kg of particulate polyester, to contact the particulate polyester with water steam. Contact between the chip of the thermoplastic polyester and water steam is performed for usually 10 minutes to 2 days, preferably 20 minutes to 10 hours. As the treating method, any of a continuous type and a batch type may be used.

In addition, in the thermoplastic polyester in the present invention, at least one kind resin selected from the group containing a polyethylene-based resin, a polypropylene-based resin, a polyolefin-based resin such as an α-olefin-based resin, and a polyacetal-based resin is incorporated at 0.1 ppb to 50000 ppm.

A method of incorporating these resins is described in JP-A No. 2002-249573, etc, in detail, which is incorporated herein by reference.

Intrinsic viscosity of the thermoplastic polyester used in the present invention, particularly the thermoplastic polyester in which main repeating unit is composed of ethylene terephthalate is in the range of preferably 0.55 to 1.50 dl/g (dl/g), more preferably 0.58 to 1.30 dl/g, further preferably 0.60 to 0.90 dl/g. When the intrinsic viscosity is less than 0.55 dl/g, the mechanical property of the resulting molded article is bad. On the other hand, when the intrinsic viscosity exceeds 1.50 dl/g, resin temperature becomes high at melting with a molding machine, and thermal degradation becomes furious, and problem arises that free low-molecular compound influencing on flavor property is increased, and the molded article is colored with yellow.

In addition, intrinsic viscosity of the thermoplastic polyester used in the present invention, particularly the thermoplastic polyester in which main repeating unit is composed of ethylene-2,6-naphthalate is in the range of 0.40 to 1.00 dl/g, preferably 0.42 to 0.95 dl/g, further preferably 0.45 to 0.90 dl/g. When the intrinsic viscosity is less than 0.40 dl/g, the mechanical property of the resulting molded article is bad. On the other hand, when the intrinsic viscosity exceeds 1.00 dl/g, resin temperature becomes higher at melting with a molding machine, and thermal degradation becomes furious, which causes problem such that free low-molecular compound influencing on the flavor property is increased, and the molded article is colored with yellow.

The intrinsic viscosity of the thermoplastic polyester of the present invention, particularly the thermoplastic polyester in which main constituent unit is composed of 1,3-propylene terephthalate is in the range of 0.50 to 2.00 dl/g, preferably 0.55 to 1.50 dl/g, further more preferably 0.60 to 1.00 dl/g. When the intrinsic viscosity is less than 0.50 dl/g, the mechanical property of the resulting molded article deteriorates, being problematic. And, upper limit of the intrinsic viscosity is 2.00 dl/g and, when the intrinsic viscosity exceeds this, resin temperature becomes high at melting with a molding machine, thermal degradation becomes furious, and molecular weight is considerably reduced, and problem arises that the molded article is colored with yellow.

In addition, the thermoplastic polyester used in the present invention may be a polyester composition containing at least two kinds of thermoplastic polyesters having substantially the same composition and having difference in the intrinsic viscosity in the range of 0.05 to 0.30 dl/g.

In addition, content of dialkylene glycol copolymerized in the thermoplastic polyester of the present invention is preferably 0.5 to 5.0% by mol, more preferably 1.0 to 4.0% by mol, further preferably 1.5 to 3.0% by mol of a glycol component constituting the thermoplastic polyester. When amount of dialkylene glycol exceeds 5.0% by mol, thermal stability deteriorates, reduction in molecular weight at molding becomes great, and increase in content of aldehydes becomes great, being not preferable. In addition, for producing the thermoplastic polyester having content of dialkylene glycol of less than 0.5% by mol, it becomes possible to select the non-economical production condition as the transesterification condition, the esterification condition or the polymerization condition, being not worth the cost. Herein, dialkylene glycol copolymerized in the thermoplastic polyester, for example, in the case of a polyester in which main constituent unit is ethylene terephthalate, is diethylene glycol (hereinafter, abbreviated as DEG) copolymerized with the thermoplastic polyester among diethylene glycols produced as a byproduct at production from ethylene glycol which is a glycol and, in the case of a polyester containing 1.3-propylene terephthalate as main constituent unit, is di(1,3-propylene glycol (hereinafter, referred to as DPG)) copolymerized with the thermoplastic polyester among di(1,3-propylene glycols) (or bis(3-hydroxypropyl)ethers) produced as a byproduct at production from 1,3-propylene glycol which is a glycol.

In addition, it is desirable that content of aldehydes such as acetaldehyde of the thermoplastic polyester of the present invention is 50 ppm or less, preferably 30 ppm or less, more preferably 10 ppm or less. Particularly, when the polyester composition of the present invention is used as material of a container for low flavor drinks such as mineral water and the like, it is desirable that content of aldehydes of the thermoplastic polyester is 8 ppm or less, preferably 5 ppm or less, more preferably 4 ppm or less. When content of aldehydes exceeds 50 ppm, the effect of retaining flavor of contents of the molded article molded from this thermoplastic polyester deteriorates. In addition, lower limit thereof is preferably 0.1 ppb from problem on production. Herein, aldehydes is acetaldehyde when the thermoplastic polyester is a polyester containing ethylene terephthalate as main constituent unit, and is allylaldehyde when the thermoplastic polyester is a polyester containing 1,3-propylene terephthalate as main constituent unit.

In addition, it is preferable that content of a cyclic ester oligomer of the thermoplastic polyester of the present invention is 70% or less, preferably 50% or less, further preferably 40% or less, particularly preferably 35% or less of content of a cyclic ester oligomer contained in melt polycondensate of the thermoplastic polyester.

Herein, the thermoplastic polyester generally contains cyclic ester oligomers of various polymerization degrees, and the cyclic ester oligomer referred in the present invention means a cyclic ester oligomer, content of which is the highest among cyclic ester oligomers contained in the thermoplastic polyester, for example, is a cyclic trimer in the case of a polyester containing ethylene terephthalate as main repeating unit.

When the thermoplastic polyester is PET which is a representative of a polyester containing ethylene terephthalate as main constituent unit, since content of cyclic trimer of a melt polycondensation polyester is about 1.0% by weight, it is preferable that content of cyclic trimer of the thermoplastic polyester of the present invention is 0.70% by weight or less, preferably 0.50% by weight or less, further preferably 0.40% by weight or less.

A polyester in which content of such the cyclic ester oligomer is reduced can be obtained by a method of solid phase-polymerization of melt polycondensation polyester, or heat-treatment of melt polycondensation polyester at temperature of melting point or lower under an inert gas.

When content of the cyclic ester oligomer exceeds 0.70% by weight, the cyclic ester oligomer ester is increased at resin melting of injection molding, chocking of an oligomer at bent part of injection molding mold becomes serious, and normal injection molding becomes impossible. In addition, adhesion of oligomer to surface of heated mold after stretch-blow molding becomes serious, transparency of the resulting hollow molded article is very deteriorated and, in the case of a film, oligomer is adhered and accumulated near outlet of die, on surface of stretching roll, and in the interior of heat fixing chamber at sheet making or at stretching, and these are adhered to film surface to become insoluble particle, being problematic. In addition, lower limit thereof is preferably 0.2% by weight from problem of the production, and problem of the production cost.

Shape of chip of the thermoplastic polyester used in the present invention may be any of cylinder, square, sphere and flat plate. An average particle diameter thereof is in the range of usually 1.3 to 5 mm, preferably 1.5 to 4.5 mm, further preferably 1.6 to 4.0 mm. For example, in the case of cylinder, it is practical that length is 1.3 to 4 mm, and diameter is around 1.3 to 4 mm. In the case of spherical particle, it is practical that maximum particle diameter is 1.1 to 2.0-fold average particle diameter, and minimum particle diameter is 0.7-fold or more average particle diameter. In addition, weight of chip is practically in the range of 5 to 30 mg/piece.

Generally, the thermoplastic polyester contains considerable amount of “fine” that is fine powder produced during production step having the same copolymerization component and the same copolymerization component content as those of chip of the thermoplastic polyester. Such the fine has nature of promoting crystallization of the thermoplastic polyester and, when the fine is present at large amount, transparency of a polyester molded article molded from the polyester composition containing such the fine very deteriorate and, in the case of a bottle, problem arises that amount of shrinkage at bottle plug crystallization does not fall within a scope of defined value, and the bottle can not be sealed with cap. Therefore, it is desirable that content the fine in the thermoplastic polyester used in the present invention is 1000 ppm or less, preferably 500 ppm or less, further preferably 300 ppm or less, particularly preferably 100 ppm or less.

In addition, it is preferable that difference between melting point of the fine in the thermoplastic polyester of the present invention and melting point of the chip is 15° C. or small, preferably 10° C. or smaller, further preferably 5° C. or smaller. When the fine having the difference exceeding 15° C. is contained, crystal melts not completely under the normally used melt molding condition, retaining as crystal nucleus. For this reason, since crystallization rate becomes great at heating of the hollow molded article plug, crystallization of the plug becomes excessive. As a result, since amount of shrinkage of the plug does not fall in defined value scope, capping at the plug becomes bad, and leakage of contents occurs. In addition, a pre-molded article for hollow molding is whitened and, for this reason, normal stretching becomes impossible, variation in thickness is generated and, since crystallization rate is great, transparency of a hollow molded article deteriorates, and variation in transparency also becomes great.

Haze of molded plate of 4 mm thickness obtained by molding the thermoplastic polyester used in the present invention at 290° C. is 10.0% or less, preferably 8.0% or less, more preferably 6.0% or less, further preferably 4.0% or less, most preferably 3.0% or less. When haze exceeds 10.0%, in a polyester molded article from the polyester composition containing such the thermoplastic polyester and partially aromatic polyamide, its crystallization rate becomes too high, and transparency is very deteriorated. Herein, haze of molded plate is value obtained by the method of the following measuring method (6).

The thermoplastic polyester having such the property can be obtained by the reaction and the treatment as described above using the antimony compound, the second metal compound and the phosphorus compound in the range of the above-described contents.

### (Partially Aromatic Polyamide)

The partially aromatic polyamide related to the present invention is a polyamide containing unit derived from aliphatic dicarboxylic acid and aromatic diamine as main constituent unit, or a polyamide containing unit derived from aromatic dicarboxylic acid and aliphatic diamine as main constituent unit.

Examples of an aromatic dicarboxylic acid component constituting the partially aromatic polyamide related to the present invention include terephthalic acid, isophthalic acid, phthalic acid, 2,6-naphthalene dicarboxylic acid, diphenyl-4,4′-dicarboxylic acid, diphenoxyethanedicarboxylic acid and functional derivatives thereof.

As the aliphatic dicarboxylic acid component constituting the partially aromatic polyamide related to the present invention, linear aliphatic dicarboxylic acid is preferable, and linear aliphatic dicarboxylic acid having an alkylene group having 4 to 12 carbon atoms is particularly preferable. Examples of such the linear aliphatic dicarboxylic acid include adipic acid, sebacic acid, malonic acid, succinic acid, glutaric acid, pimelic acid, suberic acid, azelaic acid, undecanoic acid, undecadionic acid, dodecanedionic acid, dimer acid and functional derivatives thereof.

Examples of an aromatic diamine component constituting the partially aromatic polyamide related to the present invention include metaxylylenediamine, paraxylylenediamine, and para-bis-(2-aminoethyl)benzene.

An aliphatic diamine component constituting the partially aromatic polyamide related to the present invention is aliphatic diamine of having 2 to 12 carbon atoms or functional derivatives thereof. The aliphatic diamine may be linear aliphatic diamine or chain aliphatic diamine having branch. Examples of such the linear aliphatic diamine include aliphatic diamines such as ethylenediamine, 1-methylethylenediamine, 1,3-propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, and the like.

In addition, as a dicarboxylic acid component constituting the partially aromatic polyamine related to the present invention, in addition to the above-described aromatic dicarboxylic acid and aliphatic dicarboxylic acid, alicyclic dicarboxylic acid can be also used. Examples of the alicyclic dicarboxylic acid include alicyclic dicarboxylic acids such as 1,4-cyclohexanedicarboxylic acid, hexahydroterephthalic acid, hexahydroisophthalic acid, and the like.

In addition, as a diamine component constituting the partially aromatic polyamide related to the present invention, in addition to the above-described aromatic diamine and aliphatic diamine, alicyclic diamine can be also used. Examples of the alicyclic diamine include aliphatic diamines such as cyclohexanediamine, bis-(4,4′-aminohexyl)methane, and the like.

In addition to the diamine and the dicarboxylic acid, lactams such as ε-caprolactam and laurolactam, aminocarboxylic acids such as aminocaproic acid, aminoundecanoic acid, and the like, aromatic aminocarboxylic acids such as para-aminomethylbenzoic acid, and the like can be also used as copolymerization component. Inter alia, it is desirable to use ε-caprolactam.

Preferable examples of the partially aromatic polyamide related to the present invention is metaxylylene group-containing polyamide containing at least 20% by mol or more, further preferably 30% by mol or more, particularly preferably 40% by mol or more of constituent unit derived from metaxylylenediamine, or mixed xylylenediamine containing metaxylylenediamine and paraxylylenediamine at 30% or less of total amount, and aliphatic dicarboxylic acid in molecular chain.

In addition, the partially aromatic polyamide related to the present invention may contain constituent unit derived from 3 basic or more polyvalent carboxylic acid such as trimellitic acid and pyromellitic acid in substantially linear range.

Examples of these polyamides include homopolymers such as polymetaxylyleneadipamide, polymetaxylylenesebacamide, polymetaxylylenesuberamide and the like, as well as metaxylylenediamine/adipic acid/isophthalic acid copolymer, metaxylylene/paraxylyleneadipamide copolymer, metaxylylene/paraxylylenepiperamide copolymer, metaxylylene/paraxylyleneazeramide copolymer, metaxylylenediamine/adipic acid/isophthalic acid/ε-caprolactam copolymer, metaxylylenediamine/adipic acid/isophthalic acid/ω-aminocaproic acid copolymer and the like.

In addition, preferable other examples of the partially aromatic polyamide related to the present invention is a polyamide containing at least 20% by mol or more, further preferably 30% by mol or more, particularly preferably 40% by mol or more of constituent unit derived from aliphatic diamine and at least one kind acid selected from terephthalic acid and isophthalic acid in molecular chain.

Examples of these polyamides include polyhaxamethyleneterephthalamide, polyhexamethyleneisophthalamide, hexamethylenediamine/terephthalic acid/isophthalic acid copolymer, polynonamethyleneterephthalamide, polynonamethyleneisophthalamide, nonamethylenediamine/terephthalic acid/isophthalic acid copolymer, nonamethylenediamine/terephthalic acid/adipic acid copolymer and the like.

In addition, a preferable other example of the partially aromatic polyamide related to the present invention is a polyamide containing at least 20% by mol or more, further preferably 30% by mol or more, particularly preferably 40% by mol or more of constituent unit derived from aliphatic diamine, and at least one kind acid selected from terephthalic acid and isophthalic acid, obtained by using, as a copolymerization component, lactams such as ε-caprolactam and laurolactam, aminocarboxylic acids such as aminocaproic acid, aminoundecanoic acid and the like, aromatic aminocarboxylic acids such as para-aminomethylbenzoic acid, or the like, in addition to aliphatic diamine and at least one kind acid selected from terephthalic acid and isophthalic acid, in molecular chain.

Examples of these polyamides include hexamethylenediamine/terephthalic acid/ε-caprolactam copolymer, hexamethylenediamine/isophthalic acid/ε-caprolactam copolymer, hexamethylenediamine/terephthalic acid/adipic acid/ε-caprolactam copolymer and the like.

A polyamide related to the present invention can be produced by melt polycondensation method in the presence of water or melt polycondensation method in the absence of water, or a method of further solid-phase polymerizing polyamide obtained by these melt polycondensation methods, fundamentally which has been previously known. The melt polycondensation reaction may be performed at one stage, or may be performed by dividing into multiple stages. These may be composed of a batch-type reaction apparatus, or may be composed of a continuous reaction apparatus. Alternatively, the melt polycondensation step and the solid phase polymerization step may be operated continuously, or may be operated by division.

It is preferable that a phosphorus compound or an alkali metal compound is added to the partially aromatic polyamide related to the present invention for preventing discoloration, or improving thermal stability.

It is preferable that phosphorus atom content (P) and an alkali metal atom content (M) derived from the phosphorus compound and the alkali metal compound to be added as stabilizer at the production of polyamide (total of amount of alkali metal atom contained in the phosphorus compound and amount of alkali metal contained in the alkali metal compound) satisfy ranges of the following equations (10) and (11).

30 ppm≦P≦400 ppm (10)

1<M/P molar ratio<7 (11)

Regarding P, lower limit is more preferably 50 ppm, further preferably 90 ppm or more. Upper limit is preferably 370 ppm, further preferably 350 ppm or less. Also regarding M/P molar ratio, lower limit is preferably 1.3, further preferably 1.5 or more. When phosphorus atom content is less than 30 ppm, color tone of the polymer deteriorates, and thermal stability is inferior, being not preferable. In addition, conversely, when phosphorus atom content is more than 400 ppm, a raw material expense necessary for an additive becomes great, this becomes one reason of the cost up, insoluble particle choking of filter at melt formation becomes frequent, and reduction in productivity at post step is feared. In addition, when M/P molar ratio is 1 or less, increase in viscosity is great, and there is risk that mixing of gelled material becomes frequent. In addition, conversely, when M/P molar ratio is 7 or more, reaction rate is very slow, and reduction in productivity can not be denied.

In addition, it is preferable that phosphorus atom content (P1) derived from a phosphorus compound detected in structure of the structural formula (Formula 1) in the partially aromatic polyamide related to the present invention is 10 ppm or more, more preferably 15 ppm or more, further preferably 20 ppm or more. When P1 is less than 10 ppm, thermal stability of the polyester composition of the present invention deteriorates, and not only the resulting polyester molded article is easily discolored, but also the article is easily gelled, insoluble particle and fish eye are generated more frequently in molded article such as the resulting hollow molded article and film, and flavor retainability is also deteriorated, decreasing merchandize value.

In addition, it is preferable that phosphorus atom content (P2) detected in structure of the structural formula (Formula 2) in the partially aromatic polyamide is 10 ppm or more, more preferably 20 ppm or more, further preferably 30 ppm or more. When content of P2 is 10 ppm or more, thermal stability of the polyester composition of the present invention is further improved.

Both of upper limits of P1 and P2 are 300 ppm or less, preferably 200 ppm or less, further preferably 150 ppm or less. Since phosphorus compound is oxidized during polycondensation step, it is difficult to produce polyamide having P1 exceeding 300 ppm.

Examples of the phosphorus compound used in producing polyamide related to the present invention include compounds of the following Chemical Formulas (A-1) to (A-4) and, in order to attain the object of the present invention, compounds represented by (A-1) and (A-3) are preferable, and the compound represented by (A-1) is particularly preferable.

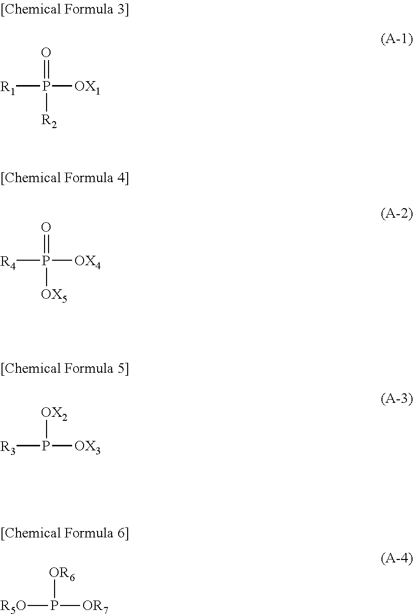

(provided that, in Chemical Formulas (A-1) to (A-4), R₁ to R₇ are hydrogen, an alkyl group, an aryl group, a cycloalkyl group, or an arylalkyl group, X₁ to X₅ are hydrogen, an alkyl group, an aryl group, a cycloalkyl group, an arylalkyl group, or an alkali metal, or an alkaline earth metal, or one of X₁ to X₅ and one of R₁ to R₇ in respective formulas may be connected together to form ring structure)

As the phosphinic acid compound represented by the Chemical Formula (A-1), examples include dimethylphosphinic acid, phenylmethylphosphinic acid, hypophosphorous acid, sodium hypophosphite, potassium hypophosphite, lithium hypophosphite, magnesium hypophosphite, calcium hypophosphite, ethyl hypophosphite,

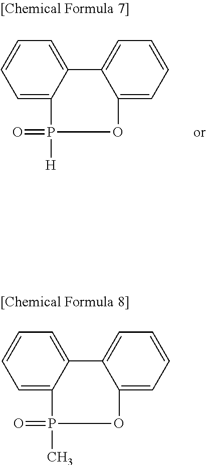

and a hydrolysate thereof, as well as condensate of the above phosphinic acid compounds.

As the phosphonic acid compound represented by the Chemical Formula (A-2), examples include phosphonic acid, sodium phosphonate, potassium phosphonate, lithium phosphonate, potassium phosphonate, magnesium phosphonate, calcium phosphonate, phenylphosphonic acid, ethylphosphonic acid, sodium phenylphosphonate, potassium phenylphosphonate, lithium phenylphosphonate, diethyl phenylphosphonate, sodium ethylphosphonate, and potassium ethylphosphonate.

As the phosphonous acid compound represented by the Chemical Formula (A-3), examples include phosphonous acid, sodium phosphonite, lithium phosphonite, potassium phosphonite, magnesium phosphonite, calcium phosphonite, phenylphosphonous acid, sodium phenylphosphonite, potassium phenylphosphonite, lithium phenylphosphonite, and ethyl phenylphosphonite.

As the phosphorous acid compound represented by the Chemical Formula (A-4), examples include phosphorous acid, sodium hydrogen phosphite, sodium phosphite, lithium phosphite, potassium phosphite, magnesium phosphite, calcium phosphite, triethyl phosphite, triphenyl phosphite, and pyrophosphorous acid.

In addition, upon production of a polyamide related to the present invention, it is preferable that an alkali metal-containing compound represented by the following Chemical Formula (B) is added. It is preferable that content of an alkali metal atom in the partially aromatic polyamide is in the range of 1 to 1000 ppm.

Z—OR₈ (B)

(wherein Z is an alkali metal, and R₈ is hydrogen, an alkyl group, an aryl group, a cycloalkyl group, —C(O)CH₃ or —C(O)OZ′ (Z′ is hydrogen or an alkali metal))

Examples of the alkali compound represented by the Chemical Formula (B) include lithium hydroxide, sodium hydroxide, potassium hydroxide, rubidium hydroxide, cesium hydroxide, lithium acetate, sodium acetate, potassium acetate, rubidium acetate, cesium acetate, sodium methoxide, sodium ethoxide, sodium propoxide, sodium butoxide, potassium methoxide, lithium methoxide, and sodium carbonate and, inter alia, it is preferable to use sodium hydroxide and sodium acetate. However, these are not limited to these compounds.

In order to incorporate the phosphorus compound or the alkali metal-containing compound into a polyamide related to the present invention, it may be added to raw material before polymerization of the polyamide, or during polymerization, or it may be melted and mixed into the polymer.

Alternatively, these compounds may be added simultaneously, or separately.

Preferable batch-type process for producing a polyamide related to the present invention will be explained below using a xylylene group-containing polyamide (Ny-MXD6) as an example, but is not limited thereto.

That is, the polyamide can be obtained, for example, by a method of heating aqueous solution of salt of metaxylylenediamine and adipic acid, and an alkali metal-containing compound containing an alkali metal atom and a phosphorus compound as thermal degradation suppressing agent under pressure or under atmospheric pressure, and polycondensing this in the melt state while removing water, and water produced by polycondensation reaction.

In this time, a tank for storing metaxylylenediamine and a tank for storing adipic acid are placed separately under the nitrogen gas atmosphere, and oxygen concentration in these nitrogen gas atmospheres is preferably 20 ppm or less, more preferably 16 ppm, most preferably 15 ppm. When oxygen content in the nitrogen gas atmosphere in storing tank exceeds 20 ppm, phosphorus atom content (P1) derived from the phosphorus compound represented by the structural formula (Formula 1) in the resulting polyamide becomes less than 10 ppm, and phosphorus atom content (P2) derived from the phosphorus compound represented by the structural formula (Formula 2) becomes less than 10 ppm, thus, thermal stability of polyamide is inferior. In addition, as a method of suppressing oxygen concentration in the atmosphere in the storing tank, a method of flowing an inert gas such as nitrogen in the tank to replace the air with nitrogen gas and, thereafter, flowing an inert gas such as nitrogen gas therein is preferable. In addition, as a method of decreasing content of oxygen in each raw material, bubbling of inert gas through a can bottom is preferable. It is preferable to use nitrogen gas having oxygen content of 12 ppm or less, more preferably nitrogen gas having oxygen content of 1 ppm or less as an inert gas.

In addition, in a step of mixing the raw material, various additives and water to prepare salt of metaxylylenediamine and adipic acid, oxygen concentration in the nitrogen gas atmosphere is 20 ppm or less, further preferably 18 ppm or less, more preferably 16 ppm, most preferably 15 ppm. Further, examples of method of reducing oxygen concentration include method of bubbling an inert gas in the aqueous salt solution, for example, using nitrogen gas. Also in this step, when oxygen content exceeds 20 ppm, phosphorus atom content (P1) derived from a phosphorus compound represented by the structural formula (Formula 1) in the resulting polyamide becomes less than 10 ppm, and phosphorus atom content (P2) derived from the phosphorus compound represented by the structural formula (Formula 2), thus, thermal stability of a polyamide is inferior.

In addition, temperature upon preparation of the salt is preferably 140° C. or less, more preferably 130° C. or less, further preferably 120° C. or less, most preferably 110° C. or less in order to suppress discoloration due to thermal oxidation deterioration, and suppress side reaction and thermal oxidation deterioration reaction of additive. In addition, lower limit is preferably temperature at which solidification of the salt does not occur, and is 30° C. or more, more preferably 40° C. or more.

Then, the above-prepared salt aqueous solution is transferred to a polymerization can to perform polycondensation and, in order to prevent flying of unreacted substances upon evaporation of water in the salt aqueous solution, and preventing mixing of oxygen into the system, temperature is gradually raised while flying pressure of 0.5 to 1.5 MPa to the interior of the can, to remove distillated water to the outside of the system, and temperature in the can is adjusted to 230° C. Reaction time thereupon is preferably 1 to 10 hours, more preferably 2 to 8 hours, further preferably 3 to 7 hours. Since rapid rise in temperature becomes one factor of increase in molecular weight of additive and progression of polymer side reaction, and becomes cause for reduction in thermal stability of resin such as gelling at post-step, this is not preferable. Thereafter, pressure in the can is gradually released over 30 to 90 minutes, returning to atmospheric pressure. Temperature is further raised, and stirring is performed at atmospheric pressure to progress polymerization reaction. Polymerization temperature is preferably 285° C. or less, more preferably 275° C. or less, further preferably 270° C. or less, most preferably 265° C. or less. When polymerization temperature is high temperature exceeding 285° C., increase in molecular weight of additive, thermal oxidation reaction and side reaction of polymer are progressed, being not preferable. Lower limit is preferably temperature in the range of not solidification based on polymer melting point. Polymerization time is preferably shorter, preferably 3 hours or less, more preferably 2 hours or less, further preferably 1.5 hours or less.

At the time point at which target viscosity is attained, stirring is stopped, and the reaction system is allowed to stand to remove air bubbles in polymer. Since allowing to stand for long period of time becomes a factor of progressing thermal degradation, this is not preferable. Melted resin is taken out through taking out port at lower part of reaction can, cooled to solidify, and cut with chip cutter such as strand cutter to obtain resin chip. Thereupon, when necessary time for casting is long, thermal oxidation degradation at the taking out port greatly influences, resin in the can undergoes thermal degradation, gelled material is generated, and the resin is discolored, being not preferable. On the other hand, when casting is too short, since temperature of strand-like polymer discharged from the taking out port becomes too high, the resin and the additive easily undergo thermal oxidation degradation, and this can be one factor of reduction in thermal stability of the polymer. Therefore, casting time is preferably 10 to 120 minutes, more preferably 15 to 100 minutes in the case of batch-type reaction can. In addition, temperature of the strand-like polymer thereupon is preferably in the range of 20 to 70° C., more preferably 30 to 65° C. As other method, an example of method of preventing thermal oxidation degradation of the polymer at the taking out port includes method of blowing an inert gas.

Relative viscosity of polyamide related to the present invention is in the range of 1.5 to 4.0, preferably 1.5 to 3.0, more preferably 1.7 to 2.5, further preferably 1.8 to 2.0. When relative viscosity is less than 1.5, molecular weight is too small, and mechanical nature of a molded article such as a film containing the polyamide related to the present invention is inferior in some cases. Conversely, when relative viscosity is 4.0 or more, polymerization takes long time, and not only this becomes cause for degradation of the polymer, gelling or unfavorable discoloration, but also productivity is reduced, becoming a factor of the cost up in some cases.

In addition, shape of chip of polyamide related to the present invention may be any of cylinder, square, sphere and flat plate. Its average particle diameter is in the range of usually 1.0 to 5 mm, preferably 1.2 to 4.5 mm, further preferably 1.5 to 4.0 mm. For example, in the case of the cylinder, practically, a length is 1.0 to 4 mm, and a diameter is around 1.0 to 4 mm. In the case of a spherical particle, practically, maximum particle diameter is 1.1 to 2.0-fold average particle diameter, and minimum particle diameter is 0.7-fold or more average particle diameter. In addition, practically, weight of the chip is in the range of 3 to 50 mg/piece.

### (Polyester Composition)

The polyester composition of the present invention is a polyester composition containing 99.9 to 80% by weight of the thermoplastic polyester, and 0.1 to 20% by weight of a partially aromatic polyamide.

When one wants to obtain a molded article which is very excellent in transparency, has very small content of aldehydes, and is excellent in flavor retainability from the polyester composition, addition amount of the partially aromatic polyamide is 0.1 to 5% by weight based on 99.9 to 95% by weight of the thermoplastic polyester. Lower limit of addition amount of the partially aromatic polyamide is more preferably 0.3% by weight, further preferably 0.5% by weight, most preferably 1.0% by weight, and upper limit is more preferably 4% by weight, further preferably 3% by weight, most preferably 2.5% by weight.

In addition, when one wants to obtain a molded article which is very excellent in gas barrier property, has transparency not deteriorating practicality, has very small content of aldehydes, and is excellent in flavor retainability, addition amount of the partially aromatic polyamide is 1 to 20% by weight based on 99 to 80% by weight of the thermoplastic polyester. Lower limit of addition amount of the partially aromatic polyamide is more preferably 3% by weight, further preferably 5% by weight, and upper limit is more preferably 10% by weight, further preferably 8% by weight.

When addition amount of the partially aromatic polyamide is less than 0.1% by weight, content of aldehydes such as AA and the like in the resulting molded article is reduced with difficulty, and flavor retainability of molded article contents becomes very worse in some cases. On the other hand, when addition amount of the partially aromatic polyamide exceeds 20% by weight, transparency of the resulting molded article easily deteriorates considerably, and mechanical characteristics of a molded article are lowered in some cases.

The equation (1) is preferably in the range of 210 to 1500, further preferably in the range of 250 to 1000. By using the polyester composition satisfying the equation (1), polyester molded article, transparency and color tone of which are not deteriorated, can be obtained with high productivity.

In addition, the equation (2) is preferably in the range of 350 to 2500, further preferably in the range of 400 to 2000. By using the polyester composition satisfying the equation (2), a polyester molded article, transparency and color tone of which are not deteriorated, can be obtained with further higher productivity.

That is, phosphorus compound added to the partially aromatic polyamide is changed into compounds having phosphorus structure in various oxidation states during polycondensation. A phosphorus structure reducing antimony compound in the thermoplastic polyester is two kinds of the structural formula (Formula 1) and the structural formula (Formula 2), and it is important that contents thereof in the polyester composition are regulated in the range of the equation (1) or the equation (2) in order to attain the object of the present invention. That is conventionally transparency and color tone of molded article deteriorate (generation of gray discoloration) by generation of antimony metal, but by regulating in the range of the equation (1) or the equation (2), the polyester composition of the present invention not only can solve these problems, but also is excellent in the infrared absorbing ability, rate of crystallization is increased, and productivity of polyester molded article is increased.

In addition, the polyester composition of the present invention which was completed aiming at further increasing productivity of a polyester molded article is a polyester composition in which a heating time (T1) of a pre-molded article containing the polyester composition at heating of the pre-molded article at 180° C., and heating time (T2) at similar heating of a pre-molded article consisting only of the thermoplastic polyester satisfy the following equation (3).

(T2−T1)/T2≧0.03 (3)

Preferably, (T2−T1)/T2≧0.05.

Further preferably, (T2−T1)/T2≧0.10.

Herein, as explained in measuring method “crystallization of a plug” described later, T1 is obtained by crystallizing a pre-molded article (perform) obtained from a polyester composition with a plug crystallizing apparatus RC-12/3 made by Osaka Reiken Co., Ltd., and measuring heating time (sec) until temperature of the plug reaches 180° C. In addition, T2 is heating time (sec) using a plug of a pre-molded article (preform) obtained from only a thermoplastic polyester by the same method.

When left part of the equation (3) is less than 0.03, there is no infrared absorbing effect, and productivity can not be improved. In addition, upper limit value is naturally limited by transparency and color tone of a molded article, and utility thereof.

Such the polyester composition of the present invention can be obtained, for example, by mixing so that phosphorus atom content (P1) in the partially aromatic polyamide, content (A) of the partially aromatic polyamide in the polyester composition and antimony atom content (S) in the polyester satisfy the equation (4), but is not limited thereto.

Further, the polyester composition of the present invention can be obtained, for example, by mixing so that phosphorus atom content (P1) in the partially aromatic polyamide, phosphorus atom content (P2) in the partially aromatic polyamide, content (A) of the partially aromatic polyamide in the polyester composition and antimony atom content (S) in the polyester satisfy the equation (5).

The equation (4) is preferably in the range of 310 to 1500, further preferably in the range of 350 to 1000. By using the polyester composition satisfying the equation (4), a polyester molded article, transparency and color tone of which are not deteriorated, can be obtained with further higher productivity.

In addition, the equation (5) is preferably in the range of 450 to 2500, further preferably in the range of 500 to 2000. By using the polyester composition satisfying the formula (5), a polyester molded article, transparency and color tone are not deteriorated, can be obtained with still further higher productivity.

That is, a phosphorus compound added to the partially aromatic polyamide is changed into compound having phosphorus structure in various oxidation states during polycondensation. Phosphorus structure of reducing antimony atom in the thermoplastic polyester is two kinds of the structural formula (Formula 1) and the structural formula (Formula 2) and, in order to attain the object of the present invention, regulate these contents in the polyester composition in the range of the equation (4) or the equation (5). By the regulations, productivity at molding can be improved, since the infrared adsorbing ability of the polyester composition is further improved.

Further, it is also possible to use a compound having the infrared adsorbing ability.

It is preferable that haze of a molded plate of 4 mm thickness obtained by molding the polyester composition of the present invention at 290° C. is 20% or less, preferably 15% or less. Particularly, in the polyester composition used in containers for drinks, it is desirable that haze is 15% or less. Haze is value obtained regarding a molded plate of 4 mm thickness obtained by the following measuring method (14).

In addition, acetaldehyde content in a polyester molded article obtained by molding the polyester composition of the present invention is 25 ppm or less, preferably 20 ppm or less. Particularly, in the polyester composition used in containers for drinks, it is desirable that acetaldehyde content is 15 ppm or less, preferably 10 ppm or less, more preferably 8 ppm or less. Acetaldehyde content is value obtained regarding a molded plate of 2 mm thickness obtained by the following measuring method (14).

When a polyester molded article obtained by molding the polyester composition of the present invention is extracted with hot water, antimony atom concentration dissolved out into water is 1.0 ppb or less, preferably 0.5 ppb or less, more preferably 0.1 ppb or less.

Concentration of dissolved out antimony atom is measured by immersing piece excised from polyester molded article by method described in the following measuring method (14) in hot water at 95° C. for 60 minutes at bath ratio of 2 ml per 1 cm² surface area, and measuring antimony atom extracted into water as antimony atom concentration dissolved out into water by flameless atomic absorption method (measuring wavelength: 217.6 nm).

The polyester composition of the present invention can be produced by adding predetermined amount of the partially aromatic polyamide at an arbitrary reaction stage from production of low polymerization degree oligomer of the thermoplastic polyester to production of melt polycondensed polymer. For example, the composition can be obtained by adding the partially aromatic polyamide in suitable shape such as fine particle, powder and melt to reactor such as esterification reactor and polycondensation reactor, or introducing the partially aromatic polyamide or a mixture of the partially aromatic polyamide and the polyester in the melt state into piping for transporting a reaction product of the polyester from the above-described reactor to a reactor at next step. Further, it is also possible to obtain the composition by solid phase-polymerizing chip obtained if necessary under high vacuum or under inert gas atmosphere.

Further, the polyester composition of the present invention can be also obtained by mixing the thermoplastic polyester and the partially aromatic polyamide by the previously known method. Examples include those obtained by dry-blending the polyamide chip and the polyester chip with tumbler, V-type blender, Henschel mixer or the like, those obtained by melt-blending the dry-blended mixture with uniaxial extruder, biaxial extruder, kneader or the like once or more, and those obtained by solid phase-polymerizing composition from melt mixture under high vacuum or inert gas atmosphere, if necessary.

Further, the polyamide may be used by grinding. Particle diameter when ground is preferably about 10 mesh or less. In addition, examples include a method of adhering solution in which the polyamide is dissolved in a solvent such as hexafluoroisopropanol, to a surface of a chip of the thermoplastic polyester, and a method of collision-contacting the thermoplastic polyester with member made of the polyester in a space where the member is present, to adhere the polyamide to surface of chip of the thermoplastic polyester.

If necessary, other additives, for example, various additives such as known ultraviolet absorbing agents, antioxidants, oxygen absorbing agents, oxygen capturing agents, lubricants which are added externally and lubricants which are internally precipitated during reaction, releasing agents, core agents, stabilizers, antistatic agents, and pigments may be incorporated into the polyester composition of the present invention. Further, ultraviolet shadowing resins, heat resistant resins, recovered products from used polyethylene terephthalate bottle, and the like may be mixed therein at suitable ratio.

The polyester composition of the present invention can be molded into a film, a sheet form product, a container, and other molded article using a melt molding method which is generally used.

Further, the polyester composition of the present invention can be molded into a molded article by adding predetermined amount of a partially aromatic polyamide to an arbitrary reactor or transporting piping at step of producing melt polycondensed polymer as described above, melt-polycondensing this so as to have objective property and, thereafter, introducing this in the melt state directly into molding step, or can be molded into a molded article by adding and mixing predetermined amount of partially aromatic polyamide into transporting piping arranged after last melt polycondensation reactor, and introducing this in the melt state directly into molding step.

A sheet form object containing the polyester composition of the present invention can be produced by the known per se means. For example, the sheet can be produced using general sheet molding machine provided with extruder and die.

Alternatively, this sheet form article may be molded into a cup or a tray by pressure forming or vacuum molding. In addition, the polyester molded article from the polyester composition of the present invention can be also in utility of a tray-like container for cooking foods in microwave oven and/or oven, or heating frozen foods. In this case, the sheet is molded into a tray shape, and thermally crystallized to improve heat resistance.

When utility of the polyester composition of the present invention is a stretched film, a sheet obtained by injection molding or extrusion molding is molded using any stretching method of uniaxial stretching, sequential biaxial stretching, and simultaneous biaxial stretching which is usually used in stretching of PET.

A specific production process regarding various utilities in the case of PET will be briefly described below.

Upon production of a stretched film, stretching temperature is usually 80 to 130° C. Stretching may be uniaxial or biaxial, but preferably is biaxial stretching from a viewpoint of practical physical property of film. In the case of uniaxial stretching, stretching may be performed at ratio in the range of usually 1.1 to 10-fold, preferably 1.5 to 8-fold and, in the case of biaxial stretching, stretching may be performed at a ratio in the range of usually 1.1 to 8-fold, preferably 1.5 to 5-fold in both of longitudinal direction and transverse direction. In addition, longitudinal direction ratio/transverse direction ratio is usually 0.5 to 2, preferably 0.7 to 1.3. The resulting stretched film may be further heat-fixed to improve heat resistance and mechanical strength. Heat fixation is performed at 120 to 240° C., preferably 150 to 230° C., usually for a few seconds to a few hours, preferably for a few tens seconds to a few minutes usually under tension.

Upon production of a hollow molded article, a preform molded from PET is stretch-blow molded, and apparatuses which have been previously used in blow molding of PET can be used. Specifically, for example, a preform is once formed by injection molding or extrusion molding, it is re-heated as it is or after procession of plug or bottom, and biaxially stretch-blow molding method such as hot parison method or cold parison method is applied. In this case, molding temperature, specifically, temperature of each part of cylinder, and nozzle of molding machine is usually in the range of 260 to 290° C. Then, plug of a preform is heated to crystallize, to produce plug-crystallized preform. For heating thereupon, infrared heater is used to heat a preform plug to 150 to 200° C., preferably 170 to 190° C.

Further, the plug-crystallized preform is heated to suitable temperature for stretching with infrared heater, then, the preform is retained in a mold of desired shape, the air is blown, this is mounted in mold, and stretch-blow molding is performed, thereby, a bottle is produced. Heating temperature at stretch-blow molding is 90 to 125° C., preferably 100 to 120° C. in the case of polyethylene terephthalate. Stretching may be performed usually in longitudinal direction at ratio in the range of 1.5 to 3.5-fold, and in circumferential direction at ratio in the range of 2 to 5-fold. The resulting hollow molded article can be used as it is and, particularly, in the case of drinks requiring thermal filling such as fruit juice drinks, and oolong tea, generally, thermal fixing treatment is further performed in blowing mold to impart thermal resistance, which is used. Thermal fixation is performed at 100 to 200° C., preferably 120 to 180° C., for a few seconds to a few hours, preferably a few seconds to a few minutes usually under tension due to pressure forming.

Further, the polyester composition of the present invention can be also used in the production of stretching hollow molded article by so-called compression molding method of melt-extruding the composition, compression-molding cut melt mass to obtain a preform, and stretch-blow molding the preform.

Methods of measuring main property values in the present invention will be explained below.

### EXAMPLES

The present invention will be explained more specifically below by way of Examples, but the present invention is not limited to these Examples. Methods of measuring main property values in the present description will be explained below.

### (Evaluation Method)

### (1) Intrinsic Viscosity (IV) of Polyester

Intrinsic viscosity was obtained from solution viscosity at 30° C. in mixed solvent of 1,1,2,2-tetrachloroethane/phenol (2:3 weight ratio).

### (2) Content of Diethylene Glycol Copolymerized in Polyester (Hereinafter, Referred to as “DEG Content”)

A sample was degraded with methanol, amount of diethylene glycol was quantitated by gas chromatography, and the content was expressed by ratio (mol %) relative to total glycol component.

### (3) Content of Cyclic Trimer (Hereinafter, Referred to as “CT Content”)

Into 3 ml of mixed solution of hexafluoroisopropanol/chloroform (volume ratio=2/3) was dissolved 300 mg of frozen and ground sample, and 30 ml of chloroform is further added to dilute the solution. Thereto was added 15 ml of methanol to precipitate polymer, which was filtered. The filtrate was evaporated to dryness, volume was adjusted to constant volume with 10 ml of dimethylformamide, and cyclic trimer was quantitated by high performance liquid chromatography method.

### (4) Acetaldehyde Content (Hereinafter, Referred to as “AA Content”)

Sample/distilled water=1 gram/2 cc was placed into nitrogen-replaced glass ample, upper part thereof is melt-sealed, extraction treatment is performed at 160° C. for 2 hours, acetaldehyde in the extract after cooling was measured by high sensitive gas chromatography, and concentration was expressed by ppm.

For the polyester compound, a plate of 2 mm thickness was taken from molded article with step obtained in (14) and, for a hollow molded article, sample was taken from center of its bottom.

### (5) Content of Remaining Catalyst in Polyester

After 2.0 g of polyester was ashed by conventional method in the presence of sulfuric acid, and the ash was dissolved in 100 ml of distilled water. Metal element in this solution was quantitated by ICP light emitting spectrophotometry.

### (6) Haze (Hazing Degree %)

Sample was cut from a molded article (4 mm wall thickness) of the following (14), and haze was measured with hazemeter, Model NDH2000 manufactured by Nippon Denshoku Industry Co., Ltd.

### (7) Co-b of Polyamide Chip

Co-b value was measured using colormeter (Model 1001DP, manufactured by Nippon Denshoku Industry Co., Ltd.).

### (8) Measurement of Content of Fine

Resin (about 0.5 kg) was placed on sieve in which sieve (A) covered with wire net of nominal dimension according to JIS-Z8801 of 5.6 mm and sieve (diameter of 20 cm) (B) covered with wire net of nominal dimension of 1.7 mm were combined, and sieving was performed with oscillating-type sieve shaking machine SNF-7 manufactured by Teraoka at 1800 rpm for 1 minute. This operation was repeated, and total of 20 kg of the resin was sieved. When fine content was small, an amount of sample was arbitrarily altered.

Fine which had been sieving-fallen below the sieve (B) was washed with 0.1% aqueous solution of cationic surfactant, then, washed with ion-exchanged water, and collected by filtration with G1 glass filter manufactured by Iwaki Glass. These together with the glass filter were dried in dryer at 100° C. for 2 hours, then cooled, and weighed. Again, the same operation of washing with ion-exchanged water and drying was repeated, constant weight was confirmed, weight of the glass filter was subtracted from this weight to obtain fine weight. Fine content is fine weight/weight of total resin applied to sieve.

### (9) Measurement of Melting Peak Temperature of Fine (Hereinafter, Referred to as “Melting Point of Fine”)

The temperature was measured using differential scanning calorimeter (DSC), RDC-220 manufactured by Seiko Instruments Inc. The fine collected from polyester in (8) was frozen, ground and mixed, and dried at 25° C. for 3 days under reduced pressure, thereafter, DSC measurement was performed at temperature rising rate of 20° C./min using 4 mg of sample in one time measurement, and melting peak temperature on highest temperature side of melting peak temperature was obtained. The measurement was performed on maximum 10 samples, and average of the melting peak temperature on highest side was obtained. In the case where melting peak was one, that temperature was obtained.

### (10) Relative Viscosity of Polyamide (Hereinafter, Referred to as “Rv”)

In 25 ml of 96% sulfuric acid was dissolved 0.25 g of sample, 10 ml of this solution was measured with an Ostwald viscosity tube at 20° C., and relative viscosity was obtained from the following equation.

Rv=t/t₀

t₀: Seconds of falling of solvent

t: Seconds of falling of sample solution

### (11) Structural Analysis of Phosphorus Compound in Polyamide (³¹P-NMR Method)

In 2.5 ml of mixed solvent of heavy benzene/1,1,1,3,3,3-hexafluoroisopropanol=1/1 (vol ratio) was dissolved 340 to 350 mg of sample, tri(t-butylphenyl)phosphoric acid (hereinafter, abbreviated as TVPPA) as P was added at 100 ppm to polyamide resin, 0.1 ml of trifluoroacetic acid was further added and, after 30 minutes, ³¹P-NMR analysis was performed with Fourier transformation nuclear magnetic resonance apparatus (AVANCE500 manufactured by BRUKER). The analysis was performed under the condition of ³¹P resonance frequency of 202.5 MHz, flip angle of detection pulse of 45°, data uptake time of 1.5 seconds, delayed time of 1.0 second, accumulation time of 10000 to 20000, measuring temperature of room temperature, and proton complete decoupling.

From the obtained NMR chart, peak integrated value of each phosphorus compound was calculated, and molar ratio of phosphorus compound represented by the structural formula (Formula 1) and phosphorus compound represented by the structural formula (Formula 2) was obtained from the following equation A.

Molar ratio of phosphorus compound=XP1/XP2 (Equation A)

(XP1 is peak integrated value of the phosphorus compound represented by the structural formula (Formula 1), and XP2 is peak integrated value of phosphorus compound represented by the structural formula (Formula 2))

Then, letting P peak integrated value corresponding to TVPPA (tri(t-butylphenyl)phosphoric acid) to be 100 ppm, total P peak integrated value PN which is sum of each P peak integrated value in polyamide observed in a range of 15 ppm to −15 ppm is calculated.

Then, P peak relative value (Ps) of all phosphorus compounds observed in NMR spectrum is obtained from the following equation B.

P peak relative value (Ps)=PN/PC (Equation B)

(PN is total P peak integrated value (ppm) of polyamide, and PC is content (ppm) of phosphorus atom in polyamide. Herein, phosphorus atom content PC in polyamide is obtained by analyzing method of the following (12). When P peak relative value is greater than 1, P peak relative value=1.)

Then, ratio (P1r) of phosphorus compound detected in structure of the structural formula (Formula 1) in polyamide, and ratio (P2r) of phosphorus compound detected in structure of the structural formula (Formula 2) are obtained from the following Equations C and D.

P1r=Ps×(P peak integrated value XP1 of phosphorus compound detected in structure of structural formula (Formula 1) in polyamide)/PN (Equation C)

P2r=Ps×(P peak integrated value XP2 of phosphorus compound detected in structure of structural formula (Formula 2) in polyamide)/PN (Equation D)

When the P peak relative value is smaller than 1, value of sum of ratio of each phosphorus compound in polyamide does not become 100, and this is due to the presence of a phosphorus compound which is not dissolved in formation of solution of polyamide by the above-described method.

In polyamides used in Examples and Comparative Examples, a phosphorus compound corresponding to the structural formula (Formula 1) is hypophosphorous acid (following (Chemical Formula 9)), and peak caused by this structure was seen in the range of 9 to 12 ppm. In addition, a phosphorus compound corresponding to the structural formula (Formula 2) is phosphorous acid (following (Chemical Formula 10)), and peak caused by this structure was seen in the range of 4 to 7 ppm.

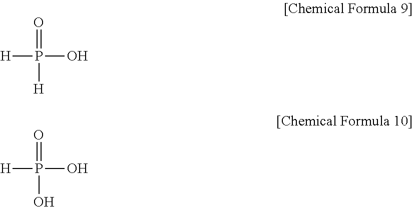

Then, by the following equation, content (P1) of phosphorus atom derived from a phosphorus compound detected in a structure of the structural formula (Formula 1) and content (P2) of phosphorus atom derived from a phosphorus compound detected in a structure of the structural formula (Formula 2) are obtained.

Content of phosphorus atom derived from phosphorus compound detected in structure of structural formula (Formula 1) (P1) (ppm)=PC×P1r

Content of phosphorus atom derived from phosphorus compound detected in structure of structural formula (Formula 2) (P2) (ppm)=PC×P2r

### (12) Analysis of P Content (P) of Polyamide

Sample was dry ashing-degraded in the presence of sodium carbonate, or wet-degraded in sulfuric acid/nitric acid/perchloric acid solution or sulfuric acid/hydrogen peroxide aqueous solution, thereby, phosphorus was converted into normal phosphoric acid. Then, molybdate salt was reacted into phosphomolybdic acid in 1 mol/L sulfuric acid solution, this was reduced with hydrazine sulfate, and absorbance of generated heteropoly acid at 830 nm was measured with photospectrometer (UV-150-02, manufactured by Shimadzu Corporation) to perform colorimetric quantitation.

### (13) Analysis of Na Content (Na) of Polyamide

Sample was ashing-degraded with platinum crucible, 6 mol/L hydrochloric acid was added, and this was evaporated to dryness. This was dissolved with 1.2 mol/L hydrochloric acid, and the solution was quantitated by atomic absorption (AA-640-12, manufactured by Shimadzu Corporation).

(14) Molding of Molded Plate with Step

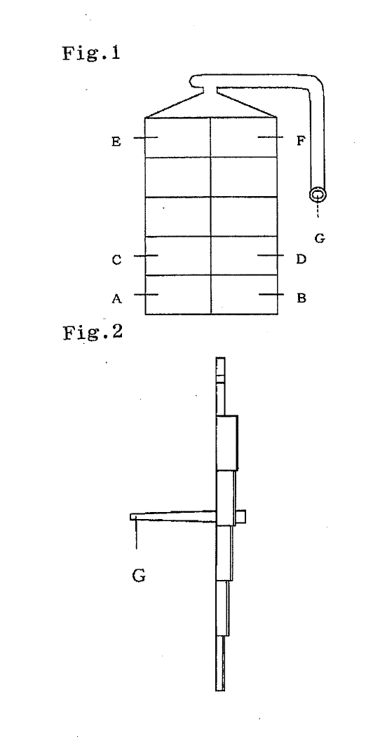

Polyester or polyester composition which had been dried at 140° C. for about 16 hours under reduced pressure using vacuum dryer, Model DP61 manufactured by Yamato Scientific Co., Ltd. was injection-molded into molded plate with step of 2 mm to 11 mm thickness (thickness of A part=2 mm, thickness of B part=3 mm, thickness of C part=4 mm, thickness of D part=5 mm, thickness of E part=10 mm, thickness of F part=11 mm) having a gate part (G) as shown in FIG. 1 and FIG. 2 with injection molding machine, Model M-150C-DM manufactured by Meiki Co., Ltd.

In order to prevent absorption of moisture during molding, the interior of molding material hopper was purged with dry inert gas (nitrogen gas). As the plasticizing condition with injection molding machine M-150C-DM, feed screw rotation number was 70%, screw rotation number was 120 rpm, back pressure was 0.5 MPa, cylinder temperature was set at 45° C., 250° C. and, thereafter, 290° C. including nozzles, in order from immediately below hopper. As the injection condition, injection rate and pressure retaining rate were adjusted at 20%, and injection pressure and retaining pressure were adjusted so that molded article weight became 146±0.2 g and, thereupon, retaining pressure was adjusted 0.5 MPa lower relative to injection pressure.

Injection time and pressure retaining time were respectively set such that upper limit was 10 seconds and 7 seconds, cooling time was set for 50 seconds, and whole cycle time including molded article taking out time was approximately about 75 seconds.

Cooling water at water temperature of 10° C. was introduced into mold at all time to regulate temperature, and temperature of mold surface at stable molding was around 22° C.

Test plate for assessing properties of molded articles was arbitrarily selected among molded articles which were stable from molding initiation to 11^{th} to 18^{th} shot after introduction of molding materials and resin replacement.

Plate of 2 mm thickness (A part of FIG. 1) was used in AA measurement, and plate of 4 mm thickness (C part of FIG. 1) was used in haze measurement.

### (15A) Molding of Hollow Molded Article [A]

Using predetermined amount of PET which had been dried with drier using nitrogen gas and predetermined amount of partially aromatic polyamide which had been dried with dryer using nitrogen gas, preform was molded with injection molding machine, Model M-150C-DM manufactured by Meiki Co., Ltd. at resin temperature of 290° C. Plug of this preform was heated to crystallize with plug crystallizing apparatus equipped with home-made infrared heater, and this was biaxial stretch-blow molded using stretch-blow molding machine, LB-01E manufactured by Corpoplast, subsequently, thermally fixed in mold set at about 150° C. to obtain 1000 cc hollow molded article.

### (15B) Molding of Hollow Molded Article [B]

Using a predetermined amount of PET which had been dried with a dryer using a nitrogen gas and a predetermined amount of partially aromatic polyamide which had been dried with a drier using a nitrogen gas, a pre-molded article was molded with an injection molding machine, Model M-150C-DM manufactured by Meiki Co., Ltd.

As the plasticizing condition with injection molding machine, M-150C-DM manufactured by Meiki Co., Ltd., feed screw rotation number was 70%, screw rotation number was 120 rpm, back pressure was 0.5 MPa, metering position was 50 mm, and cylinder temperature was set so that melt resin temperature became 45° C., 250° C. and, thereafter, 290° C. including nozzles, in order from immediately below hopper. As the injection condition, injection rate and pressure retaining rate were 10%, and injection pressure and retaining pressure were adjusted so that weight of molded article became 58.6±0.2 g and, thereupon, retaining pressure was adjusted to lower by 0.5 MPa relative to injection pressure. Cooling time was set for 20 seconds, and whole cycle time including molded article taking out time was approximately about 42 seconds. Size of the preform was such that outer diameter was 29.4 mm, length was 145.5 mm, and wall thickness was about 3.7 mm.

Cooling water at water temperature of 18° C. was introduced into mold at all time to regulate temperature, and temperature of mold surface at stable molding was around 29° C. Preform for assessing properties was arbitrarily selected among molded articles which were stable from molding initiation to 20^{th} to 50^{th} shot after introduction of molding materials and resin replacement.

Plug of this preform was heated to crystallize with plug crystallizing apparatus equipped with home-made infrared heater, and this was biaxial stretch-blow molded at PF temperature set at 100 to 120° C. using stretch-blow molding machine, LB-01E manufactured by Corpoplast to obtain 1500 cc hollow molded article. In the case of PET alone, it was molded as described above.

### (16A) Crystallization of Plug

Preform separately obtained by the method of (15A) was crystallized with plug crystallizing apparatus, RC-12/3 of Osaka Reiken Co., Ltd., and heating time (sec) until plug temperature reached 180° C. was measured, which was designated as “heating time”. For measuring temperature, Thermotracer TH3102MR (manufactured by NEC Sanei Co., Ltd.) which is high sensitivity radiation thermometer, was used.

### (16B) Crystallization of Plug

Preform separately obtained by the method of (15B) from the polyester composition was crystallized with plug crystallizing apparatus, RC-12/3 of Osaka Reiken Co., Ltd., and heating time (sec) until plug temperature reached 180° C. (T1) was measured. In addition, heating time (sec) for preform from only PET (T2) was measured by the same method. For measuring temperature, Thermotracer TH3102MR (manufactured by NEC Sanei Co., Ltd.) which is high sensitivity radiation thermometer, was used.

Calculation was performed from the following equation.

(T2−T1)/T2

### (17) Density of Plug

From an upper end of a plug of the crystallized preform, a sample was excised into a size of 3 mm square, which was used as a test piece.

A density was measured by a density gradient tube method.

### (18) Transparency of Hollow Molded Article

100^{th} molded article obtained in (15) was visually observed, and assessed as follows.

⊙: The molded articles are transparent

◯: The molded articles are transparent in practical range, and insoluble particle such as unmelted substance is not seen.

Δ: The molded articles are transparent in practical range, but insoluble particle such as unmelted substance is recognized.

x: The molded articles are inferior in transparency, gray discoloration is recognized, or unmelted substance is seen.

### (19) Functional Test

Boiling distilled water was placed into the hollow molded article obtained in (15), the molded article was sealed, retained for 30 minutes, cooled to room temperature, and allowed to stand at room temperature for 1 month and, after plug opening, test on flavor and odor was performed.

As blank for comparison, distilled water was used. The functional test was performed by 10 panelists according to the following criteria, and comparison was performed by average.

### (Evaluation Standard Score)

Strange taste or an odor is not felt: 4

Slight difference between blank is felt: 3

Difference between blank is felt: 2

Considerably difference between blank is felt: 1

Very great difference between blank is felt: 0

### (Average Av)

⊙: 3.5≦Av

◯: 2.5≦Av<3.5

Δ: 1.5≦Av<2.5

x: 0.5≦Av<1.5

xx: Av<0.5

(20) Dissolved Out Antimony Atom (Sb) Concentration (ppb)

Piece excised from the molded article of 2 mm thickness obtained in (14) was immersed in hot water at 95° C. for 60 minutes so that bath ratio became 2 ml per surface area 1 cm², and antimony extracted into water was measured with flameless atomic absorption method (measuring wavelength: 217.6 nm) as antimony atom concentration dissolved into water.

(Polyethylene terephthalate (PET) used in Examples and Comparative Examples)

### (Polyester 1 (Pes(1)))

Into system in which reaction product was present in the first esterification reaction apparatus were continuously supplied EG slurry of TPA having adjusted molar ratio of EG relative to TPA of 1.7, and EG solution of antimony trioxide at such amount that antimony atom per 1 ton of produced polyester resin became 1.40 mol (about 170 ppm relative to produced polyester resin), and they were reacted at temperature of 255° C. and atmospheric pressure for average retention time of 4 hours.

This reaction product was continuously taken out to the outside of the system, and supplied to the second esterification reaction apparatus, and this was reacted at temperature of 260° C. and atmospheric pressure for average retention time of each tank of 2.5 hours.

Then, the esterification reaction product was continuously taken out from the second esterification reaction apparatus, and continuously supplied to continuous polycondensation reaction apparatus. From a plurality of polycondensation catalyst supplying pipings connected to a piping for transporting the esterification reaction product, EG solution of phosphoric acid at such amount that phosphorus atom per 1 ton of the produced polyester resin became 0.65 mol (about 20 ppm relative to produced polyester resin), and EG solution of magnesium acetate tetrahydrate at such amount that magnesium atom per 1 ton of the produced polyester resin became 0.62 mol (about 15 ppm relative to the produced polyester resin) were supplied to the esterification reaction product, and this was polycondensed at about 265° C. and 25 torr for 1 hour under stirring, then, at about 265° C. and 3 torr for 1 hour under stirring in the second polycondensation reactor and, further, at about 275° C. and 0.5 to 1 torr under stirring in the final polycondensation reactor. Intrinsic viscosity of the melt-polycondensed prepolymer was 0.57 gl/g.

The melt-polycondensed reaction product was chipped while cooling with cooling water having about 800/10 ml of particles of particle diameter of 1 to 25 μm, sodium content of 0.02 ppm, magnesium content of 0.01 ppm, calcium content of 0.01 ppm and silicon content of 0.10 ppm, obtained by treating industrial water with filter filtration apparatus and ion exchange apparatus, so that chip temperature became about 40° C. or less, this was transported to storage tank, then, fine and film-form material were removed by vibration sealing step and air stream classification step to fine content of about 100 ppm or less. Then, this was sent to crystallization apparatus, continuously crystallized at about 155° C. for 3 hours under nitrogen gas flowing, then, placed into tower-type solid phase polymerization equipment, and solid phase-polymerized continuously at about 206° C. to obtain solid phase-polymerized polyester. The polyester was continuously treated at post-solid phase polymerization sieving step and fine removing step to remove fine and film-like material.

Intrinsic viscosity of the obtained PET was 0.75 dl/g, DEG content was 2.7% by mol, content of cyclic trimer was 0.35% by weight, AA content was 3.2 ppm, fine content was 100 ppm, melting point of fine was 248° C., and haze of molded plate was 0.9%. Antimony content measured by atomic absorption analysis was about 170 ppm.

Evaluation of this PET by molded plate was performed. Results are shown in Table 1.

### (Polyester 2 (Pes(2)))

Polyester 2 was obtained by reacting in the same method as that of the polyester 1 except that in place of magnesium acetate, EG solution of cobalt acetate at such amount that cobalt atom per 1 ton of the produced polyester resin became 0.34 mol (about 20 ppm relative to the produced polyester resin), EG solution of phosphoric acid at such amount that phosphorus atom per 1 ton of the produced polyester resin became 0.65 mol (about 20 ppm relative to the produced polyester resin), and EG solution of antimony trioxide at such amount that antimony atom per 1 ton of the produced polyester resin became 1.56 mol (about 190 ppm relative to the produced polyester resin) were used.

Properties of the obtained PET are shown in Table 1.

### (Polyester 3 (Pes(3)))

A polyester 3 was obtained by reacting in the same method as that of the polyester 1 except that EG solution of magnesium acetate tetrahydrate at such amount that magnesium atom per 1 ton of the produced polyester resin became 1.23 mol (about 30 ppm relative to the produced polyester resin), EG solution of phosphoric acid at such amount that phosphorus atom per 1 ton of the produced polyester resin 0.97 mol (about 30 ppm relative to the produced polyester resin), and antimony atom per 1 ton of the produced polyester resin became 2.79 mol (340 ppm relative to the produced polyester resin) were used.

Properties of the obtained PET are shown in Table 1.

### (Polyester 4 (Pes(4)))

Polyester 4 was obtained by reacting in the same method as that of the polyester 1 except that second metal compound was not used, and EG solution of phosphoric acid at amount described in Table 1 as phosphorus atom per 1 ton of the produced polyester resin, and EG solution of antimony trioxide at amount described in Table 1 as antimony atom per 1 ton of the produced polyester resin were used.

Properties of the obtained PET are shown in Table 1.

### (Polyester 5 (Pes(5)))

Polyester 5 was obtained by reacting in the same method as that of the polyester 1 except that second metal compound was not used, and EG solution of phosphorous acid at amount described in Table 1 as phosphorus atom per 1 ton of the produced polyester resin, and EG solution of antimony trioxide at amount described in Table 1 as antimony atom per 1 ton of the produced polyester resin were used. In this respect, as water for cooling the melt-polycondensed prepolymer, industrial water was used as it was, and fine was not removed from the prepolymer, or the polymer after solid phase polymerization.

Properties of the obtained PET are shown in Table 1.

TABLE 1

| | | | | | | Content | | | | | | | |
|---|---|---|---|---|---|---|---|---|---|---|---|---|---|
| | | | | | | of metal | | | | | | | |
| | | | | | | from | | | | | | | |
| | | | | | S | second | Me | | | | | Melting | Haze of |
| | | AA | CT | | (mol/ | metal | (mol/ | Phosphor | P | Me/P | Content | point | molded |
| | IV | content | content | S | resin | compound | resin | content | (mol/resin | (molar | of fine | of fine | plate |
| | (dl/g) | (ppm) | (wt %) | (ppm) | 1 ton) | (ppm) | 1 ton) | (ppm) | 1 ton) | ratio) | (ppm) | (° C.) | (%) |
| Pes | 0.75 | 3.2 | 0.35 | 170 | 1.40 | 15 | 0.62 | 20 | 0.65 | 0.95 | 100 | 248 | 0.9 |
| (1) | | | | | | | | | | | | | |
| Pes | 0.75 | 3.3 | 0.34 | 190 | 1.56 | 20 | 0.34 | 20 | 0.65 | 0.52 | 80 | 250 | 1.1 |
| (2) | | | | | | | | | | | | | |
| Pes | 0.75 | 3.4 | 0.31 | 340 | 2.79 | 30 | 1.23 | 30 | 0.97 | 1.27 | 80 | 251 | 1.5 |
| (3) | | | | | | | | | | | | | |
| Pes | 0.75 | 3.3 | 0.33 | 230 | 1.99 | — | — | 30 | 0.97 | — | 100 | 250 | 15.1 |
| (4) | | | | | | | | | | | | | |
| Pes | 0.75 | 3.5 | 0.32 | 450 | 3.45 | — | — | 35 | 1.13 | — | 2000 | 276 | 50.0 |
| (5) | | | | | | | | | | | | | |

### (Partially Aromatic Polyamide Used in Examples and Comparative Examples)

### (Ny-MXD6 (A))

Predetermined amounts of precisely weighed metaxylylenediamine, adipic acid and water were added to preparation can equipped with stirrer, partial condenser, thermometer, addition funnel and nitrogen gas introducing tube, operation of pressurizing and pressure release with nitrogen gas was repeated five times to perform nitrogen replacement to oxygen content in atmospheric nitrogen of 9 ppm or less. Inner temperature thereupon was 80° C. Further, as additive, NaOH and NaH₂PO₂.H₂O were added, and this was stirred to obtain uniform salt aqueous solution. Thereupon, oxygen content in atmospheric nitrogen was maintained at 7 ppm or less.

This solution was transferred to reaction can equipped with stirrer, partial condenser, thermometer, addition funnel and nitrogen gas introducing tube, temperature was gradually raised at the can internal temperature of 190° C. and the can internal pressure of 1.0 MPa, distilled water was removed to the outside of the system, and the can internal temperature was adjusted at 230° C. Reaction time until this time was 5 hours. Thereafter, can internal pressure was gradually released over 60 minutes, returning to atmospheric pressure. Further, temperature was raised to 255° C., the reaction was stirred at room temperature for 20 minutes to reach a predetermined viscosity, and the reaction was completed. Thereafter, this was allowed to stand for 20 minutes, air bubbles in the polymer were removed, melt resin was extruded through the reaction can lower part, and casting was performed while cooled and solidified with cold water. Casting time was about 70 minutes, and temperature of cooled and solidified resin was 50° C. Amount of sodium was adjusted to be 1.65-fold mol of phosphorus atom as total amount of sodium atoms of sodium hypophosphite and sodium hydroxide. Properties of the obtained Ny-MXD6 are shown in Table 2.

### (Ny-MXD6 (B), (C), (F))

According to the same polymerization method as that of Ny-MXD6 (A) except that NaOH and NaH₂PO₂.H₂O were added to content described in Table 2, Ny-MXD6 was obtained. Properties of the obtained Ny-MXD6 are shown in Table 2.

### (Ny-MXD6 (D))

According to the same polymerization method as that of Ny-MXD6 (A) except that amount ratio of metaxylylenediamine and adipic acid was changed, Ny-MXD6 (D) was obtained. Properties of the obtained Ny-MXD6 are shown in Table 2.

### (Ny-MXD6 (E))

According to the same polymerization method as that of Ny-MXD6 (A) except that the phosphorus atom-containing compound and the alkali compound were not added, Ny-MXD6 (E) was obtained. Properties of the obtained Ny-MXD6 are shown in Table 2.

TABLE 2

| | | P | P | | | | | Na | Na/P | |
|---|---|---|---|---|---|---|---|---|---|---|
| | | content | (mol/resin | P1 | P2 | P1 + P2 | Na | (mol/resin | (molar | |
| | RV | (ppm) | 1 ton) | (ppm) | (ppm) | (ppm) | (ppm) | 1 ton) | ratio) | Co-b |
| Ny-MXD6(A) | 2.00 | 400 | 12.90 | 270 | 95 | 365 | 490 | 21.3 | 1.65 | 0.2 |
| Ny-MXD6(B) | 2.00 | 300 | 9.68 | 145 | 100 | 245 | 400 | 17.39 | 1.80 | 0.1 |
| Ny-MXD6(C) | 2.00 | 100 | 3.23 | 30 | 35 | 65 | 300 | 13.04 | 4.04 | 0.7 |
| Ny-MXD6(D) | 1.70 | 200 | 6.45 | 100 | 40 | 140 | 400 | 17.39 | 2.70 | 0.5 |
| Ny-MXD6(E) | 2.00 | — | — | — | — | — | — | — | — | 11.0 |
| Ny-MXD6(F) | 2.00 | 60 | 1.94 | 20 | 25 | 45 | 200 | 8.70 | 4.84 | 0.9 |

### Example 1

Using 0.5% by weight of Ny-MXD6 (A) relative to 99.5% by weight of Pes (2), evaluation was performed by the above-described assessing method. Method of molding hollow molded article [A] was performed. The obtained evaluation results are shown in Table 3.

P1×A×S in the polyester composition was 256, ((P1+P2)×A×S)/100 was 347, and an AA content of the molded article from this polyester composition was small as 10 ppm, and there was no problem.

In addition, infrared absorbing property of preform obtained from this composition was good, and crystallization temperature reaching time was shortened to 142 seconds. In addition, transparency of a bottle was ⊚, and functional test was ◯, and there was no problem.

### Examples 2 to 9

Regarding polyester compositions described in Table 3, evaluation was performed in the same manner as in Example 1.

The obtained evaluation results are shown in Table 3.

Results were all not problematic.

### Comparative Example 1

Using 5% by weight of Ny-MXD6 (E) relative to 95% by weight of Pes (1), evaluation was performed in the same manner as in Example 1. The obtained evaluation results are shown in Table 3.

Infrared absorbing property of preform obtained from this composition was bad, and crystallization temperature reaching time was long as 155 seconds. In addition, unmelted substance was recognized in bottle, transparency thereof was x, and functional test was x, being problematic.

### Comparative Examples 2 and 3

Using compositions described in Table 3, evaluation was performed in the same manner as in Example 1. The obtained evaluation results are shown in Table 3.

### Comparative Example 4

Using only Pes (5), evaluation was performed in the same manner as in Example 1. The obtained evaluation results are shown in Table 3.

TABLE 3

| | | Item | Example 1 | Example 2 | Example 3 | Example 4 | Example 5 | Example 6 | Example 7 |
|---|---|---|---|---|---|---|---|---|---|
| Polyester | Components of | Res(1) | | 99 | 98 | | | 90 | |
| composition | composition | Res(2) | 99.5 | | | 97 | 95 | | |
| | (% by weight) | Res(3) | | | | | | | 99 |
| | | Res(4) | | | | | | | |
| | | Res(5) | | | | | | | |
| | | Ny-MXD6(A) | 0.5 | 1 | 2 | | | | 1 |
| | | Ny-MXD6(B) | | | | 3 | | | |
| | | Ny-MXD6(C) | | | | | | | |
| | | Ny-MXD6(D) | | | | | 5 | 10 | |
| | | Ny-MXD6(E) | | | | | | | |
| | Properties of | (P1 × A × S)/100 | 256 | 459 | 918 | 827 | 950 | 1700 | 918 |
| | composition | ((P1 + P2) × A × S)/ | 347 | 620 | 1241 | 1397 | 1330 | 2380 | 1241 |
| | | 100 | | | | | | | |
| | | 2 mm molded | 10 | 10 | 9 | 9 | 7 | 6 | 11 |
| | | plate AA (ppm) | | | | | | | |
| | | 4 mm molded | 0.7 | 0.8 | 0.8 | 0.9 | 1.2 | 9.7 | 1.7 |
| | | plate Haze (%) | | | | | | | |
| Hollow | Properties | Heating time | 142 | 140 | 133 | 136 | 135 | 130 | 134 |
| molded | | (sec) | | | | | | | |
| article | | Plug | 1.377 | 1.378 | 1.378 | 1.377 | 1.378 | 1.380 | 1.379 |
| | | density (g/cm³) | | | | | | | |
| | | Dissolved out | 0.49 | 0.48 | 0.48 | 0.47 | 0.46 | 0.45 | 0.47 |
| | | antimony | | | | | | | |
| | | concentration | | | | | | | |
| | | (ppb) | | | | | | | |
| | | AA content | 10 | 10 | 10 | 10 | 8 | 7 | 11 |
| | | (ppm) | | | | | | | |
| | | Transparency | ⊙ | ◯ | ◯ | ◯ | ◯ | ◯ | ◯ |
| | | Functional test | ◯ | ⊙ | ⊙ | ⊙ | ⊙ | ⊙ | ⊙ |

| | | | | | Comparative | Comparative | Comparative | Comparative |
|---|---|---|---|---|---|---|---|---|
| | | Item | Example 8 | Example 9 | Example 1 | Example 2 | Example 3 | Example 4 |
| Polyester | Components of | Res(1) | | | 95 | | | |
| composition | composition | Res(2) | | 82 | | | | |
| | (% by weight) | Res(3) | 98 | | | | | |
| | | Res(4) | | | | 90 | | |
| | | Res(5) | | | | | 95 | 100 |
| | | Ny-MXD6(A) | 2 | | | | | |
| | | Ny-MXD6(B) | | | | | 5 | |
| | | Ny-MXD6(C) | | 18 | | 10 | | |
| | | Ny-MXD6(D) | | | | | | |
| | | Ny-MXD6(E) | | | 5 | | | |
| | Properties of | (P1 × A × S)/100 | 1836 | 1026 | 0 | 690 | 3045 | — |
| | composition | ((P1 + P2) × A × S)/ | 2482 | 2223 | 0 | 1495 | 5145 | — |
| | | 100 | | | | | | |
| | | 2 mm molded | 9 | 6 | 18 | 6 | 10 | 22 |
| | | plate AA (ppm) | | | | | | |
| | | 4 mm molded | 2.1 | 10.1 | 27.8 | 34.2 | 15.6 | 0.3 |
| | | plate Haze (%) | | | | | | |
| Hollow | Properties | Heating time | 130 | 130 | 155 | 141 | 125 | 155 |
| molded | | (sec) | | | | | | |
| article | | Plug | 1.380 | 1.380 | 1.373 | 1.378 | 1.380 | 1.375 |
| | | density (g/cm³) | | | | | | |
| | | Dissolved out | 0.47 | 0.44 | 1.5 | 0.60 | 0.50 | 1.5 |
| | | antimony | | | | | | |
| | | concentration | | | | | | |
| | | (ppb) | | | | | | |
| | | AA content | 10 | 7 | 17 | 7 | 17 | 28 |
| | | (ppm) | | | | | | |
| | | Transparency | ◯ | ◯ | X | X | X | ⊙ |
| | | Functional test | ⊙ | ⊙ | X | ◯ | X | XX |

### Example 10

Using 1% by weight of Ny-MXD6 (A) relative to 99% by weight of Pes (1), evaluation was performed by the above-described assessing method. Method of molding hollow molded article [B] was performed. The obtained evaluation results are shown in Table 4.

P1×A×S/100 in the polyester composition was 459, ((P1+P2)×A×S)/100 was 620, and AA content of molded article from this polyester composition was small as 10 ppm, and there was no problem.

In addition, infrared absorbing property of preform obtained from this composition was good, crystallization temperature reaching time was short as 141 seconds, and (T2−T1)/T2 was 0.08. In addition, transparency of the bottle was ⊚, and functional test was ⊚, and there was no problem.

### Examples 11 to 18

Regarding polyester compositions described in Table 4, evaluation was performed in the same manner as in Example 10.

Resulting evaluation results are shown in Table 4.

All of the results had no problem.

### Comparative Example 5

Using 5% by weight of Ny-NXD6 (E) relative to 95% by weight of Pes (1), evaluation was performed in the same manner as in Example 10. The obtained evaluation results are shown in Table 4.

Infrared absorbing property of preform obtained from this composition was poor, and crystallization temperature reaching time was long as 152 seconds. In addition, unmelted substance was recognized in the bottle, transparency thereof was x, and functional test was x, being problematic.

### Comparative Example 6

Using only Pes (4), evaluation was performed in the same manner as in Example 10. The obtained evaluation results are shown in Table 4.

### Comparative Example 7

Using 0.5% by weight of Ny-MXD6 (A) relative to 99.5% by weight of Pes (1), evaluation was performed in the same manner as in Example 10. The obtained evaluation results are shown in Table 4.

Transparency of the bottle was ⊚, and functional test was ◯, and there was no problem.

However, infrared absorbing property of preform obtained from this composition was poor, and crystallization temperature reaching time was long as 150 seconds.

Comparative Example 7 corresponds to Example of claims 1 to 7 of the present invention, but is Comparative Example of claims 8 to 15 of the present invention.

TABLE 4

| | | Item | Example 10 | Example 11 | Example 12 | Example 13 | Example 14 | Example 15 |
|---|---|---|---|---|---|---|---|---|
| Polyester | Components of | Res(1) | 99 | 98 | | | | 90 |
| composition | composition | Res(2) | | | 97 | 95 | 95 | |
| | (% by weight) | Res(3) | | | | | | |
| | | Res(4) | | | | | | |
| | | Res(5) | | | | | | |
| | | Ny-MXD6(A) | 1 | 2 | | | | |
| | | Ny-MXD6(B) | | | 3 | 5 | | |
| | | Ny-MXD6(C) | | | | | | |
| | | Ny-MXD6(D) | | | | | 5 | 10 |
| | | Ny-MXD6(E) | | | | | | |
| | Properties of | (P1 × A × S)/100 | 459 | 918 | 827 | 1378 | 950 | 1700 |
| | composition | ((P1 + P2) × | 620 | 1241 | 1397 | 2328 | 1330 | 2380 |
| | | A × S)/100 | | | | | | |
| | | 2 mm molded | 10 | 9 | 9 | 8 | 7 | 6 |
| | | plate AA (ppm) | | | | | | |
| | | 4 mm molded | 0.8 | 0.8 | 0.9 | 1.5 | 1.2 | 9.7 |
| | | plate Haze (%) | | | | | | |
| Hollow | Properties | Heating time | 141 | 132 | 135 | 133 | 134 | 132 |
| molded | | (sec) T1 (sec) | | | | | | |
| article | | (T2 − T1)/T2 | 0.08 | 0.14 | 0.12 | 0.13 | 0.12 | 0.14 |
| | | Plug density | 1.377 | 1.378 | 1.378 | 1.379 | 1.379 | 1.380 |
| | | (g/cm³) | | | | | | |
| | | Dissolved out | 0.45 | 0.43 | 0.42 | 0.41 | 0.40 | 0.40 |
| | | antimony | | | | | | |
| | | concentration | | | | | | |
| | | (ppb) | | | | | | |
| | | AA content | 11 | 11 | 10 | 8 | 8 | 7 |
| | | (ppm) | | | | | | |
| | | Transparency | ⊙ | ◯ | ◯ | ◯ | ◯ | ◯ |
| | | Functional | ⊙ | ⊙ | ⊙ | ⊙ | ⊙ | ⊙ |
| | | test | | | | | | |
| | | | | | | Comparative | Comparative | Comparative |
| | | Item | Example 16 | Example 17 | Example 18 | Example 5 | Example 6 | Example 7 |
| Polyester | Components of | Res(1) | | | | 95 | | 99.5 |
| composition | composition | Res(2) | | | 82 | | | |
| | (% by weight) | Res(3) | 99 | 98 | | | | |
| | | Res(4) | | | | | 100 | |
| | | Res(5) | | | | | | |
| | | Ny-MXD6(A) | 1 | 2 | | | | 0.5 |
| | | Ny-MXD6(B) | | | | | | |
| | | Ny-MXD6(C) | | | 18 | | | |
| | | Ny-MXD6(D) | | | | | | |
| | | Ny-MXD6(E) | | | | 5 | | |
| | Properties of | (P1 × A × S)/100 | 918 | 1836 | 684 | 0 | — | 230 |
| | composition | ((P1 + P2) × | 1241 | 2482 | 1539 | 0 | — | 310 |
| | | A × S)/100 | | | | | | |
| | | 2 mm molded | 11 | 9 | 10 | 18 | 22 | 15 |
| | | plate AA (ppm) | | | | | | |
| | | 4 mm molded | 1.2 | 2.2 | 0.9 | 27.8 | 0.3 | 0.6 |
| | | plate Haze (%) | | | | | | |
| Hollow | Properties | Heating time | 135 | 132 | 140 | 152 | 153 | 150 |
| molded | | (sec) T1 (sec) | | | | | | |
| article | | (T2 − T1)/T2 | 0.12 | 0.14 | 0.08 | 0.01 | — | 0.02 |
| | | Plug density | 1.379 | 1.380 | 1.378 | 1.373 | 1.370 | 1.375 |
| | | (g/cm³) | | | | | | |
| | | Dissolved out | 0.41 | 0.40 | 0.44 | 1.5 | 1.5 | 0.73 |
| | | antimony | | | | | | |
| | | concentration | | | | | | |
| | | (ppb) | | | | | | |
| | | AA content | 11 | 10 | 7 | 17 | 30 | 16 |
| | | (ppm) | | | | | | |
| | | Transparency | ◯ | ◯ | ◯ | X | ⊙ | ⊙ |
| | | Functional | ⊙ | ⊙ | ⊙ | X | XX | ◯ |
| | | test | | | | | | |

As described above, the polyester composition of the present invention was explained above based on a plurality of Examples, but the present invention is not limited by features described in the Examples, and features can be arbitrarily changed by arbitrarily combining features described in respective Examples in such a range that the gist thereof is not departed.

### INDUSTRIAL APPLICABILITY

According to the polyester composition of the present invention, a polyester molded article which does not damage transparency and color tone, and is excellent in flavor retainability and thermal stability, or flavor retainablity, thermal stability and gas barrier property is obtained, and the polyester molded article of the present invention is very suitable as a molded article for drinks such as refreshing drinks as described above.

1. A polyester composition comprising 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, phosphorus atom content (P1) in the partially aromatic polyamide, the partial aromatic polyamide content (A) in the polyester composition, and antimony atom content (S) in the thermoplastic polyester satisfy the following equation (1), and haze of a molded plate of 4 mm thickness obtained by molding the polyester composition at 290° C. is 20% or less.
(Provided that P1 is content of phosphorus atom derived from a phosphorus compound detected in structure of the following structural formula (Formula 1), when the partially aromatic polyamide is dissolved in a solvent for 31P-NMR measurement solvent, trifluoroacetic acid is added, and the structure is analyzed.) 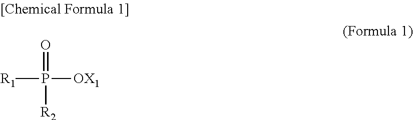
(wherein R1 and R2 represent hydrogen, an alkyl group, an aryl group, a cycloalkyl group or an arylalkyl group, and X1 represents hydrogen)
200≦(P1×A×S)/100≦2000 (1)
In the equation (1),
P1: content (ppm) of phosphorus atom derived from a phosphorus compound detected in the structural formula (Formula 1) of the partially aromatic amide
A: content (% by weight) of the partially aromatic polyamide in the polyester composition
S: content (ppm) of antimony atom in the thermoplastic polyester.

2. A polyester composition comprising 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, content (P1) of phosphorus atom in the partially aromatic polyamide, content (P2) of phosphorus atom in the partial aromatic polyamide, content (A) of the partially aromatic polyamide in the polyester composition and antimony atom content (S) in the thermoplastic polyester satisfy the following equation (2), and haze of a molded plate of 4 mm thickness obtained by molding the polyester composition at 290° C. is 20% or less.
(provided that P1 is content of phosphorus atom derived from a phosphorus compound detected in structure of the structural formula (Formula 1), and P2 is content of phosphorus atom derived from a phosphorus compound detected in structure of the structural formula (Formula 2), when the partially aromatic polyamide is dissolved in a solvent for 31P-NMR measurement, trifluoroacetic acid is added, and structure is analyzed) 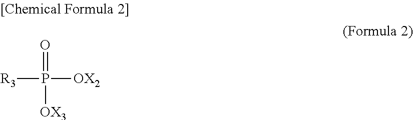
(wherein R3 represents hydrogen, an alkyl group, an aryl group, a cycloalkyl group or an arylalkyl group, and X2 and X3 represent hydrogen)
300≦{(P1+P2)×A×S}/100≦3000 (2)
In the equation (2),
P1: content (ppm) of phosphorus atom derived from a phosphorus compound detected in the structural formula (Formula 1) in the partially aromatic polyamide
P2: content (ppm) of phosphorus atom derived from a phosphorus compound detected in the structural formula (Formula 2) in the partially aromatic polyamide
A: content (% by weight) of the partially aromatic polyamide in the polyester composition
S: antimony atom content (ppm) in the thermoplastic polyester

3. The polyester composition of claim 1, wherein antimony atom content remaining in the thermoplastic polyester is 100 to 400 ppm.

4. The polyester composition of claim 1, wherein acetaldehyde content of a molded article obtained by injection-molding the polyester composition is 15 ppm or less.

5. The polyester composition of claim 1, wherein when a molded article obtained from the polyester composition is extracted with hot water, antimony atom concentration dissolved in water is 1.0 ppb or less.

6. A polyester molded article obtained by molding the polyester composition of claim 1.

7. The polyester molded article of claim 6, wherein the polyester molded article is any one of a hollow molded article, a sheet form article, and a stretched film obtained by stretching this sheet form article at least in one direction.

8. A polyester composition comprising 99.9 to 80% by weight of a thermoplastic polyester containing an antimony compound and 0.1 to 20% by weight of a partially aromatic polyamide, wherein a time (T1) for heating a pre-molded article containing the polyester composition when the pre-molded article is heated to 180° C., and time (T2) for heating the pre-molded article consisting only of the thermoplastic polyester similarly satisfy the following equation (3).
(T2−T1)/T2≧0.03 (3)

9. The polyester composition of claim 8, comprising 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, content (P1) of phosphorus atom in the partially aromatic polyamide, content (A) of the partially aromatic polyamide in the polyester composition, and antimony atom content (S) in the thermoplastic polyester satisfy the following equation (4), and haze of a molded plate of 4 mm thickness obtained by molding the polyester compound at 290° C. is 20% or less.
(provided that, P1 is content of phosphorus atom derived from a phosphorus compound detected in a structure of the structural formula (Formula 1))
300≦(P1×A×S)/100≦2000 (4)
In the equation (4),
P1: content (ppm) of phosphorus atom derived from a phosphorus compound detected in the structural formula (Formula 1) in the partially aromatic polyamide
A: content (% by weight) of the partially aromatic polyamide in the polyester composition
S: antimony atom content (ppm) in the thermoplastic polyester

10. The polyester composition of claim 8, comprising 99.9 to 80% by weight of a thermoplastic polyester containing an antimony compound and 0.1 to 20% by weight of a partially aromatic polyamide, wherein haze of a molded plate of 4 mm thickness obtained by molding the thermoplastic polyester at 290° C. is 10% or less, content (P1) of phosphorus atom in the partially aromatic polyamide, content (P2) of phosphorus atom in the partially aromatic polyamide, content (A) of the partially aromatic polyamide in the polyester composition and antimony atom content (S) in the thermoplastic polyester satisfy the following equation (5), and haze of a molding plate of 4 mm thickness obtained by molding the polyester composition at 290° C. is 20% or less.
(provided that, P1 is content of phosphorus atom derived from a phosphorus compound detected in a structure of the structural formula (Formula 1), and P2 is content of phosphorus atom derived from a phosphorus compound detected in a structure of the structural formula (Formula 2))
400≦{(P1+P2)×A×S}/100≦3000 (5)
In the equation (5),
P1: content (ppm) of phosphorus atom derived from a phosphorus compound detected in the structural formula (Formula 1) in the partially aromatic polyamide
P2: content (ppm) of phosphorus atom derived from a phosphorus compound detected in the structural formula (Formula 2) in the partially aromatic polyamide
A: content (% by weight) of the partially aromatic polyamide in the polyester composition
S: antimony atom content (ppm) in the thermoplastic polyester

11. The polyester composition of claim 8, wherein antimony atom content remaining in the thermoplastic polyester is 100 to 400 ppm.

12. The polyester composition of claim 8, wherein acetaldehyde content of a molded article obtained by injection-molding the polyester composition is 15 ppm or less.

13. The polyester composition of claim 8, wherein when a molded article obtained from the polyester composition is extracted with hot water, antimony atom concentration dissolved in the water is 1.0 ppb or less.

14. A polyester molded article obtained by molding the polyester composition of claim 8.

15. The polyester molded article of claim 14, wherein the polyester molded article is any one of a hollow molded article, a sheet form article, and a stretched film obtained by stretching this sheet form article at least in one direction.

16. The polyester composition of claim 2, wherein antimony atom content remaining in the thermoplastic polyester is 100 to 400 ppm.

17. The polyester composition of claim 2, wherein acetaldehyde content of a molded article obtained by injection-molding the polyester composition is 15 ppm or less.

18. The polyester composition of claim 2, wherein when a molded article obtained from the polyester composition is extracted with hot water, antimony atom concentration dissolved in water is 1.0 ppb or less.

19. A polyester molded article obtained by molding the polyester composition of claim 2.

20. The polyester molded article of claim 19, wherein the polyester molded article is any one of a hollow molded article, a sheet form article, and a stretched film obtained by stretching this sheet form article at least in one direction.
